(19) United States
(12) Patent Application Publication
(10) Pub. No.: US 2019/0133122 A1
(43) Pub. Date: May 9, 2019

(54) FUNGICIDAL OR BACTERICIDAL COMPOSITION AND METHOD FOR CONTROLLING DISEASE

(71) Applicant: Nissan Chemical Corporation, Chuo-ku (JP)

(72) Inventors: Nakako HASUNUMA, Chuo-ku (JP); Yasuhiro FUKAMI, Chuo-ku (JP)

(73) Assignee: Nissan Chemical Corporation, Chuo-ku (JP)

(21) Appl. No.: 16/094,153

(22) PCT Filed: Apr. 26, 2017
(86) PCT No.: PCT/JP2017/016593

§ 371 Date: Oct. 16, 2018

(30) Foreign Application Priority Data
Apr. 27, 2016 (JP) 2016-089737
Mar. 6, 2017 (JP) 2017-041802

(51) Int. Cl. A01N 33/08; A01N 43/10; A01N 43/36; A01N 43/40; A01N 43/56; A01N 43/60; A01N 43/78

(52) U.S. Cl. CPC A01N 33/08; A01N 43/10; A01N 43/36; A01N 43/78; A01N 43/56; A01N 43/60; A01N 43/40

(57) ABSTRACT

A fungicidal or bactericidal composition containing an active ingredient A of an oxime-substituted amide compound represented by the formula (I), or its N-oxide or its salt, and an active ingredient (B) as a fungicidal or bactericidal compound:

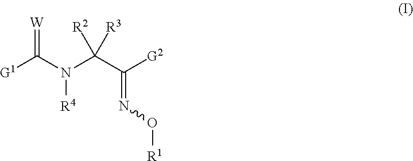

where in the formula (I), G¹ is a structure of the following G¹-1, G¹-2, G¹-3, G¹-4, G¹-5, G¹-6, G¹-7, G¹-8 or G¹-9, G² is a structure of the following G²-1 or G²-2, W is an oxygen atom or a sulfur atom, R¹ is C₁-C₆ alkyl, halo (C₁-C₄) alkyl, (C₁-C₄) alkyl substituted by R¹⁰, C₃-C₆ cycloalkyl, C₃-C₆ alkenyl, halo (C₃-C₄) alkenyl, C₃-C₆ alkynyl or phenyl, R² is a hydrogen atom, methyl or ethyl, provided that R² is methyl or ethyl when G¹ is a structure of G¹-1, X¹ is a chlorine atom, X², X³ and X⁵ each is a hydrogen atom, X⁴ is a hydrogen atom or a chlorine atom, and G² is a structure of G²-1, Y³ is a chlorine atom, Y¹, Y², Y⁴ and Y⁵ each is a hydrogen atom, R³ is a hydrogen atom or methyl, or R² and R³ may together form a cyclopropyl ring, R⁴ is a hydrogen atom, halo (C₁-C₄) alkylthio, C₁-C₄ alkylcarbonyl or C₁-C₄ alkoxycarbonyl.

### TECHNICAL FIELD

The present invention relates to a novel composition for controlling plant diseases, which comprises a specific oxime-substituted amide compound, or its N-oxide or its salt, and an active ingredient compound of a specific fungicidal or bactericidal agent, and a method for controlling plant diseases.

### BACKGROUND ART

An oxime-substituted amide compound represented by the formula (I), or its N-oxide or its salt, as the first active ingredient compound in the fungicidal or bactericidal composition of the present invention, is known to be a pesticidal agent, as its activities (see Patent Document 1).

A compound being active ingredient B as the second active ingredient in the fungicidal or bactericidal composition of the present invention, is known as a compound having fungicidal activities or bactericidal activities (see Patent Documents 4 to 6 and Non-Patent Document 1).

Further, a fungicidal or bactericidal composition containing a specific oxime-substituted amide compound, or its N-oxide or its salt, and a compound having a specific fungicidal or bactericidal activity (see Patent Document 2); and a nematicide composition containing a specific oxime-substituted amide compound, or its N-oxide or its salt, and a compound having a specific nematicidal activity (see Patent Document 3), are known.

### PRIOR ART DOCUMENTS

### Patent Documents

Patent Document 1: WO2014/010737
Patent Document 2: WO2015/119246
Patent Document 3: WO2015/147199
Patent Document 4: WO2011/081174
Patent Document 5: WO2012/020772
Patent Document 6: WO2013/162072

### Non-Patent Document

Non-Patent Document 1: The Pesticide Manual, 16th edition, The British Crop Protection Council, 2012

### DISCLOSURE OF INVENTION

### Technical Problem

Plant diseases caused by infection of various pathogens on plants such as cereals, fruits, vegetables, ornamental plants, etc., will cause deterioration of the quality of agricultural crops, significant reduction in yield, and in some cases, even a serious damage such as death of plants, and thus present a significant economic loss not only to producers but also to consumers. Therefore, effective control of such plant diseases is a very important issue, in order to achieve efficient and stable production of agricultural crops. From this point of view, heretofore, developments of pest control agents for the purpose of controlling plant diseases have been made, and many effective pesticides have been put into practical use to date.

However, due to years of use of these pesticides, in recent years, there have been an increasing number of cases where pathogens have acquired resistance to such pesticides, and pest control by existing plant disease controlling agents which have been used heretofore, tends to be difficult. In addition, such a problem has become apparent that some of the existing plant disease control agents are highly toxic, or some remain for a long time in the environment to create a problem of disrupting the ecosystem. Under these circumstances, it is now consistently desired to develop a new plant disease control agent which not only has excellent controlling activities against pathogenic bacteria, but also has a high level of control characteristics such as low toxicity and low residual properties, and an effective controlling method.

It is an object of the present invention to provide a novel plant disease control agent which exhibits excellent controlling activities against pathogens, and has characteristics such as low toxicity and low residual properties, and a plant disease control method.

### Solution to Problem

As a result of extensive research with an aim to solve the above problem, the present inventors have found that a composition comprising, in combination, a specific oxime-substituted amide compound represented by the following formula (I), or its N-oxide or its salt (active ingredient A), and a specific compound having fungicidal or bactericidal activities (active ingredient B), exhibits synergistic, excellent fungicidal or bactericidal effects, which cannot be predicted from a case of using each compound alone, and thus, the present invention has been accomplished.

That is, the present invention provides, as its gist, a composition as defined in the following [1] to [63] (hereinafter referred to also as the composition of the present invention), and a disease control method as defined in [64] to [71] (hereinafter referred to also as the method of the present invention).

[1] A fungicidal or bactericidal composition comprising synergistically effective amounts of the following active ingredient A and the following active ingredient B:

(1) active ingredient A: an oxime-substituted amide compound represented by the following formula (I), or its N-oxide or its salt,

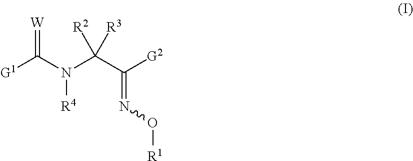

in the formula (I), G¹ is a structure of the following G¹-1, G¹-2, G¹-3, G¹-4, G¹-5, G¹-6, G¹-7, G¹-8 or G¹-9,

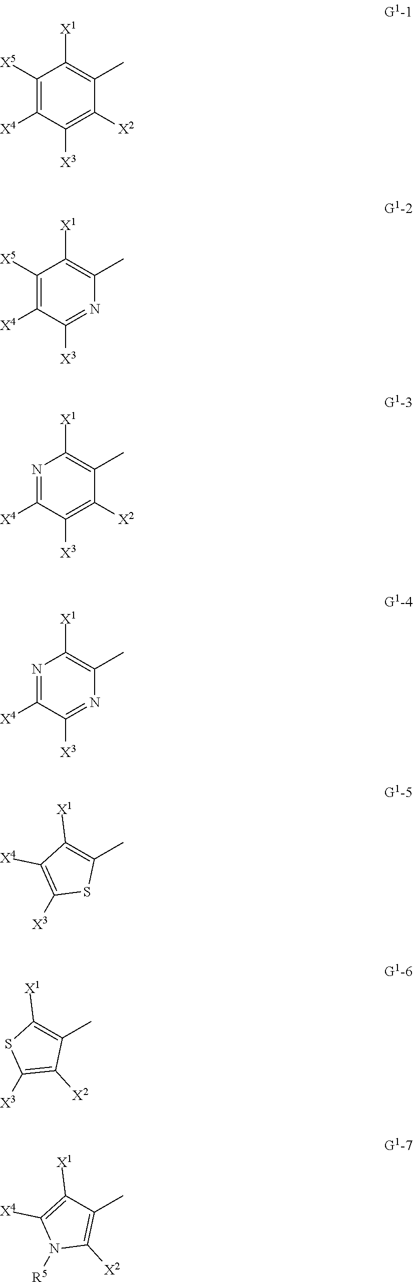

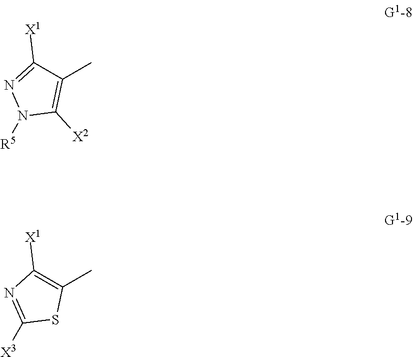

G² is a structure of the following G²-1 or G²-2,

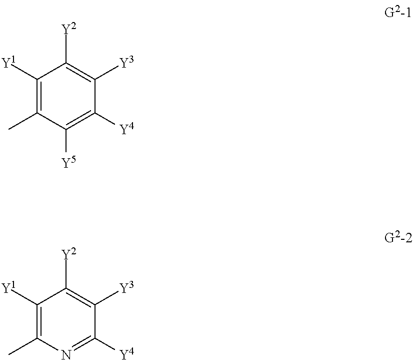

W is an oxygen atom or a sulfur atom,

X¹ is a halogen atom, nitro, methyl, difluoromethyl or trifluoromethyl,

X² is a hydrogen atom, and further when G¹ is a structure of G¹-8 and X¹ is trifluoromethyl, X² may be a halogen atom,

X³ is a hydrogen atom or methyl,

X⁴ is a hydrogen atom or a halogen atom,

X⁵ is a hydrogen atom,

Y¹ is a hydrogen atom, a halogen atom, methyl, trifluoromethyl or methoxy,

Y² is a hydrogen atom, a halogen atom, cyano, C₁-C₆ alkoxy, methylthio, methylsulfinyl or methylsulfonyl,

Y³ is a hydrogen atom, a halogen atom, cyano, C₁-C₄ alkyl, trifluoromethyl, C₂-C₄ alkenyl, C₂-C₆ alkynyl, (C₂-C₆) alkynyl optionally substituted by R⁶, —OR^{7a}, C₁-C₄ alkylthio, —C(R⁸)═NOR⁹ or phenyl,

Y⁴ is a hydrogen atom or a halogen atom,

Y⁵ is a hydrogen atom,

R¹ is C₁-C₆ alkyl, halo (C₁-C₄) alkyl, (C₁-C₄) alkyl substituted by R¹⁰, C₃-C₆ cycloalkyl, C₃-C₆ alkenyl, halo (C₃-C₄) alkenyl, C₃-C₆ alkynyl or phenyl,

R² is a hydrogen atom, methyl or ethyl, provided that R² is methyl or ethyl when G¹ is a structure of G¹-1, X¹ is a chlorine atom, X². X³ and X⁵ each is a hydrogen atom, X⁴ is a hydrogen atom or a chlorine atom, and G² is a structure of G²-1, Y³ is a chlorine atom, Y¹, Y², Y⁴ and Y⁵ each is a hydrogen atom,

R³ is a hydrogen atom or methyl, or R² and R³ may together form a cyclopropyl ring,

R⁴ is a hydrogen atom, halo (C₁-C₄) alkylthio, C₁-C₄ alkylcarbonyl or C₁-C₄ alkoxycarbonyl,

R⁵ is methyl,

R⁶ is a halogen atom, C₃-C₆ cycloalkyl, hydroxy(C₃-C₆)cycloalkyl, C₅-C₆ cycloalkenyl, —OH, —OR^{7b}, C₁-C₄ alkylcarbonyloxy, C₁-C₄ alkylsulfonyloxy, C₁-C₄ alkylthio, trimethylsilyl, —C(R⁸)═NOR⁹, phenyl or phenyl substituted by (Z)ₘ,

R^{7a} and R^{7b} each independently is C₁-C₄ alkyl, halo (C₁-C₄) alkyl, C₁-C₄ alkoxy (C₁-C₂) alkyl, C₃-C₄ alkynyl or phenyl substituted by (Z)ₘ,

R⁸ is a hydrogen atom or methyl,

R⁹ is methyl or ethyl,

R¹⁰ is cyano, C₃-C₆ cycloalkyl, C₁-C₄ alkoxy, C₁-C₄ alkylthio, trimethylsilyl, —C(R¹¹)═NOR¹², phenyl or phenyl substituted by (Z)ₘ,

R¹¹ is methyl,

R¹² is methyl or ethyl,

Z is a halogen atom, cyano, nitro, C₁-C₄ alkyl, trifluoromethyl, methoxy, trifluoromethoxy, trifluoromethytthio or phenyl, and when m is 2 or more, the respective Z's may be identical with or different from one another, and when there are two neighboring Z's, the two neighboring Z's may form —CH═CH—CH═CH— to form a 6-membered ring together with the carbon atoms attached to the two Z's,

m is an integer of 1, 2 or 3,

(2) active ingredient B: one or more compounds selected from the group consisting the following B-I group to B-XV group,

B-I group: pydiflumetofen, pyraziflumid and 1-(2-[([1-(4-chlorophenyl)-1H-pyrazol-3-yl]oxy)-methyl]-3-methylphenyl)-4-methyl-1,4-dihydro-5H-tetrazol-5-one,

B-II group: fenpyrazamine,

B-III group: metalaxy-M, oxadixyl and hymexazol,

B-IV group: carbendazim and zoxamide,

B-V group: enoxastrobin, fenaminstrobin, triclopyricarb and cyazofamid,

B-VI group: kasugamycin and streptomycin,

B-VII group: propamocarb hydrochloride and Bacillus subtilis,

B-VIII group: imibenconazole, propiconazole, pyrisoxazole, triadimefon and triflumizole,

B-IX group: mefentrifluconazole,

B-X group: validamycin, dimethomorph and mandipropamid,

B-XI group: copper oxychloride, basic copper sulfate and thiram,

B-XII group: zineb,

B-XIII group: cymoxanil and fosetyl-aluminium,

B-XIV group: quinofumelin, 2-(2-[(7,8-difluoro-2-methylquinolin-3-yl)oxy]-6-fluoro-phenyl)propan-2-ol, dipymetitrone, ethylicin and 3-chloro-4-(2,6-difluorophenyl)-6-methyl-5-phenyl-pyridazine,

B-XV group: dimetachlone, zhongshengmycin, thiodiazole-copper, zinc thiazole, fenaminosuif, wuyiencin, ningnanmycin, berberine and copper(I) oxide.

[2] The fungicidal or bactericidal composition according to the above [1], wherein the active ingredient A is the compound of the above formula (I), or its N-oxide or its salt, wherein,

W is an oxygen atom.

X¹ is a halogen atom, methyl, difluoromethyl or trifluoromethyl,

X² is a hydrogen atom,

X⁴ is a hydrogen atom,

Y¹ is a halogen atom,

Y² is a hydrogen atom, a halogen atom, C₁-C₆ alkoxy, methylthio, methylsulfinyl or methylsulfonyl,

Y³ is a halogen atom, trifluoromethyl, C₂-C₄ alkenyl, C₂-C₆ alkynyl, (C₂-C₆) alkynyl optionally substituted by R⁶, —OR^{7a} or —C(R⁸)═NOR⁹,

R¹ is C₁-C₆ alkyl, halo (C₁-C₄) alkyl, (C₁-C₄) alkyl substituted by R¹⁰, C₃-C₆ cycloalkyl, C₃-C₆ alkenyl, halo (C₃-C₄) alkenyl or C₃-C₆ alkynyl,

R² is a hydrogen atom or methyl, provided that R² is methyl when G² is a structure of G²-1,

R³ is a hydrogen atom,

R⁴ is a hydrogen atom,

R⁶ is a halogen atom, C₃-C₆ cycloalkyl, —OR^{7b}, trimethylsilyl, —C(R⁸)═NOR⁹ or phenyl,

R^{7a} is halo (C₁-C₄) alkyl,

R^{7b} is C₁-C₄ alkyl or C₁-C₄ alkoxymethyl,

R¹⁰ is C₃-C₆ cycloalkyl, trimethylsilyl, phenyl or phenyl substituted by (Z)m,

Z is a halogen atom or cyano, and when m is 2 or more, the respective Z's may be identical with or different from one another.

[3] The fungicidal or bactericidal composition according to the above [2], wherein the active ingredient A is the compound of the above formula (I), or its N-oxide or its salt, wherein,

G¹ is a structure of G¹-1, G¹-3, G¹-8 or G¹-9,

G² is a structure of G²-2,

X¹ is a chlorine atom, difluoromethyl or trifluoromethyl,

Y¹ is a chlorine atom or a bromine atom,

Y² is a hydrogen atom, C₁-C₄ alkoxy or methylsulfonyl,

Y³ is a chlorine atom, a bromine atom, trifluoromethyl, C₂-C₆ alkynyl or (C₂-C₆) alkynyl optionally substituted by R⁶,

Y⁴ is a hydrogen atom,

R¹ is C₁-C₄ alkyl, halo (C₁-C₄) alkyl or cyclopropylmethyl,

R² is a hydrogen atom or methyl,

R^{e} is cyclopropyl or phenyl.

[4] The fungicidal or bactericidal composition according to the above [3], wherein the active ingredient A is the compound of the above formula (I), or its N-oxide or its salt, wherein,

G¹ is a structure of G¹-1,

X¹ is trifluoromethyl,

X³ is a hydrogen atom.

[5] The fungicidal or bactericidal composition according to the above [3], wherein the active ingredient A is the compound of the above formula (I), or its N-oxide or its salt, wherein,

G¹ is a structure of G¹-3,

X¹ is a chlorine atom or difluoromethyl,

X³ is a hydrogen atom.

[6] The fungicidal or bactericidal composition according to the above [3], wherein the active ingredient A is the compound of the above formula (I), or its N-oxide or its salt, wherein,

G¹ is a structure of G¹-8,

X¹ is difluoromethyl.

[7] The fungicidal or bactericidal composition according to the above [3], wherein the active ingredient A is the compound of the above formula (I), or its N-oxide or its salt, wherein,

G¹ is a structure of G¹-9,

X¹ is difluoromethyl,

X³ is methyl.

[8] The composition according to any one of the above [1] to [3], wherein the active ingredient A is the compound of the above formula (I), or its N-oxide or its salt, wherein,

G¹ is a structure of G¹-1.

[9] The composition according to any one of the above [1] to [3], wherein the active ingredient A is the compound of the above formula (I), or its N-oxide or its salt, wherein,

G¹ is a structure of G¹-3.

[10] The composition according to any one of the above [1] to [3], wherein the active ingredient A is the compound of the above formula (I), or its N-oxide or its salt, wherein,

G¹ is a structure of G¹-8.

[11] The composition according to any one of the above [1] to [3], wherein the active ingredient A is the compound of the above formula (I), or its N-oxide or its salt, wherein,

G¹ is a structure of G¹-9.

[12] The composition according to any one of the above [1] to [11], wherein the active ingredient A is the compound of the above formula (I), or its N-oxide or its salt, wherein,

G² is a structure of G²-1.

[13] The composition according to any one of the above [1] to [11], wherein the active ingredient A is the compound of the above formula (I), or its N-oxide or its salt, wherein,

G² is a structure of G²-2.

[14] The composition according to any one of the above [1] to [13], wherein the active ingredient A is the compound of the above formula (I), or its N-oxide or its salt, wherein,

W is an oxygen atom.

[15] The composition according to any one of the above [1] to [3] or [8] to [14], wherein the active ingredient A is the compound of the above formula (I), or its N-oxide or its salt, wherein, X¹ is a chlorine atom.
[16] The composition according to any one of the above [1] to [3] or [8] to [14], wherein the active ingredient A is the compound of the above formula (I), or its N-oxide or its salt, wherein,

X¹ is difluoromethyl.

[17] The composition according to any one of the above [1] to [3] or [8] to [14], wherein the active ingredient A is the compound of the above formula (I), or its N-oxide or its salt, wherein,

X¹ is trifluoromethyl.

[18] The composition according to any one of the above [1] to [17], wherein the active ingredient A is the compound of the above formula (I), or its N-oxide or its salt, wherein,

X² is a hydrogen atom.

[19] The composition according to any one of the above [1] to [17], wherein the active ingredient A is the compound of the above formula (I), or its N-oxide or its salt, wherein,

X² is a halogen atom.

[20] The composition according to any one of the above [1] to [3] and [8] to [19], wherein the active ingredient A is the compound of the above formula (I), or its N-oxide or its salt, wherein,

X³ is a hydrogen atom.

[21] The composition according to any one of the above [1] to [3] and [8] to [19], wherein the active ingredient A is the compound of the above formula (I), or its N-oxide or its salt, wherein,

X³ is methyl.

[22] The composition according to any one of the above [1] to [21], wherein the active ingredient A is the compound of the above formula (I), or its N-oxide or its salt, wherein,

X⁴ is a hydrogen atom.

[23] The composition according to any one of the above [1] to [21], wherein the active ingredient A is the compound of the above formula (I), or its N-oxide or its salt, wherein,

X⁴ is a halogen atom.

[24] The composition according to any one of the above [1] to [23], wherein the active ingredient A is the compound of the above formula (I), or its N-oxide or its salt, wherein,

Y¹ is a chlorine atom.

[25] The composition according to any one of the above [1] to [23], wherein the active ingredient A is the compound of the above formula (I), or its N-oxide or its salt, wherein,

Y¹ is a bromine atom.

[26] The composition according to any one of the above [1] to [25], wherein the active ingredient A is the compound of the above formula (I), or its N-oxide or its salt, wherein,

Y² is a hydrogen atom.

[27] The composition according to any one of the above [1] to [25], wherein the active ingredient A is the compound of the above formula (I), or its N-oxide or its salt, wherein,

Y² is a C₁-C₄ alkoxy.

[28] The composition according to any one of the above [1] to [25], wherein the active ingredient A is the compound of the above formula (I), or its N-oxide or its salt, wherein,

Y² is methylsulfonyl.

[29] The composition according to any one of the above [1] to [28], wherein the active ingredient A is the compound of the above formula (I), or its N-oxide or its salt, wherein,

Y³ is a chlorine atom or a bromine atom.

[30] The composition according to any one of the above [1] to [28], wherein the active ingredient A is the compound of the above formula (I), or its N-oxide or its salt, wherein,

Y³ is trifluoromethyl.

[31] The composition according to any one of the above [1] to [28], wherein the active ingredient A is the compound of the above formula (I), or its N-oxide or its salt, wherein,

Y³ is C₂-C₅ alkynyl.

[32] The composition according to any one of the above [1] to [28], wherein the active ingredient A is the compound of the above formula (I), or its N-oxide or its salt, wherein,

Y³ is (C₂-C₆) alkynyl optionally substituted by R⁶.

[33] The composition according to any one of the above [1] to [32], wherein the active ingredient A is the compound of the above formula (I), or its N-oxide or its salt, wherein,

Y⁴ is a hydrogen atom.

[34] The composition according to any one of the above [1] to [32], wherein the active ingredient A is the compound of the above formula (I), or its N-oxide or its salt, wherein,

Y⁴ is a halogen atom.

[35] The composition according to any one of the above [1] to [34], wherein the active ingredient A is the compound of the above formula (I), or its N-oxide or its salt, wherein,

R¹ is C₁-C₄ alkyl.

[36] The composition according to any one of the above [1] to [34], wherein the active ingredient A is the compound of the above formula (I), or its N-oxide or its salt, wherein,

R¹ is halo (C₁-C₄) alkyl.

[37] The composition according to any one of the above [1] to [34], wherein the active ingredient A is the compound of the above formula (I), or its N-oxide or its salt, wherein,

R¹ is cyclopropylmethyl.

[38] The composition according to any one of the above [1] to [37] wherein the active ingredient A is the compound of the above formula (I), or its N-oxide or its salt, wherein,

R² is a hydrogen atom.

[39] The composition according to any one of the above [1] to [37], wherein the active ingredient A is the compound of the above formula (I), or its N-oxide or its salt, wherein,

R² is methyl.

[40] The composition according to any one of the above [1] to [39], wherein the active ingredient A is the compound of the above formula (I), or its N-oxide or its salt, wherein,

R³ is a hydrogen atom.

[41] The composition according to any one of the above [1] to [39], wherein the active ingredient A is the compound of the above formula (I), or its N-oxide or its salt, wherein,

R³ is methyl.

[42] The composition according to any one of the above [1] to [41], wherein the active ingredient A is the compound of the above formula (I), or its N-oxide or its salt, wherein,

R⁶ is cyclopropyl.

[43] The composition according to any one of the above [1] to [41], wherein the active ingredient A is the compound of the above formula (I), or its N-oxide or its salt, wherein,

R⁶ is phenyl.

[44] The fungicidal or bactericidal composition according to any one of the above [1] to [43], wherein the active ingredient B is a compound selected from the B-I group.
[45] The fungicidal or bactericidal composition according to any one of the above [1] to [43], wherein the active ingredient B is a compound selected from the B-II group.
[46] The fungicidal or bactericidal composition according to any one of the above [1] to [43], wherein the active ingredient B is a compound selected from the B-III group to the B-VIII group, the B-X group to B-XIII group and the B-XV group.
[47] The composition according to any one of the above [1] to [43], wherein the active ingredient B is a compound selected from the B-III group.
[48] The composition according to any one of the above [1] to [43], wherein the active ingredient B is a compound selected from the B-IV group.
[49] The composition according to any one of the above [1] to [43], wherein the active ingredient B is a compound selected from the B-V group.
[50] The composition according to any one of the above [1] to [43], wherein the active ingredient B is a compound selected from the B-VI group.
[51] The composition according to any one of the above [1] to [43], wherein the active ingredient B is a compound selected from the B-VII group.
[52] The composition according to any one of the above [1] to [43], wherein the active ingredient B is a compound selected from the B-VIII group.
[53] The composition according to any one of the above [1] to [43], wherein the active ingredient B is a compound selected from the B-IX group.
[54] The composition according to any one of the above [1] to [43], wherein the active ingredient B is a compound selected from the B-X group.
[55] The composition according to any one of the above [1] to [43], wherein the active ingredient B is a compound selected from the B-XI group.
[56] The composition according to any one of the above [1] to [43], wherein the active ingredient B is a compound selected from the B-XII group.
[57] The composition according to any one of the above [1] to [43], wherein the active ingredient B is a compound selected from the B-XIII group.
[58] The fungicidal or bactericidal composition according to any one of the above [1] to [43], wherein the active ingredient B is a compound selected from the B-XIV group.
[59] The composition according to any one of the above [1] to [43], wherein the active ingredient B is a compound selected from the B-XV group.
[60] The fungicidal or bactericidal composition according to any one of the above [1] to [59], wherein the active ingredient B is contained in a proportion of from 0.001 to 1000 parts by weight, relative to 1 part by weight of the active ingredient A.
[61] The composition according to any one of the above [1] to [59], wherein the active ingredient B is contained in a proportion of from 0.01 to 100 parts weight, relative to 1 part by weight of the active ingredient A.
[62] The composition according to any one of the above [1] to [59], wherein the active ingredient B is contained in a proportion of from 0.1 to 50 weight, relative to 1 part by weight of the active ingredient A.
[63] The composition according to any one of the above [1] to [59], wherein the active ingredient B is contained in a proportion of from 0.1 to 10 parts by weight, relative to 1 part by weight of the active ingredient A.
[64]. A method for controlling disease or bacteria, by treatment at the same time or in close temporal proximity with the active ingredient A as defined in any one of the above [1] to [43] and the active ingredient B as defined in any one of the above [1] and [44] to [63].
[65]. The method for controlling disease or bacteria according to the above [64], wherein the active ingredient B is used in a proportion of from 0.001 to 1000 parts by weight, relative to 1 part by weight of the active ingredient A.
[66]. The method for controlling disease or bacteria according to the above [64], wherein the active ingredient B is used in a proportion of from 0.01 to 100 parts by weight, relative to 1 part by weight of the active ingredient A.
[67]. The method for controlling disease or bacteria according to the above [64], wherein the active ingredient B is used in a proportion of from 0.1 to 50 parts by weight, relative to 1 part by weight of the active ingredient A.
[68]. The method for controlling disease or bacteria according to the above [64], wherein the active ingredient B is used in a proportion of from 0.1 to 10 parts by weight, relative to 1 part by weight of the active ingredient A.
[69] A method for controlling disease or bacteria by foliage application of the composition as defined in any one of the above [1] to [63], to a plant.
[70] A method for controlling disease or bacteria by application of the composition as defined in any one of the above [1] to [63], to a soil for plant growth.
[71] A method for controlling disease or bacteria by application of the composition as defined in any one of the above [1] to [63], to seeds, a tuberous root or rhizome of a plant.

### Advantageous Effects of Invention

The fungicidal or bactericidal composition of the present invention, and the disease control method using the composition of the present invention, exhibit synergistic excellent controlling effects against plant diseases caused by various pathogens, and also exhibit synergistic sufficient controlling effects even against pathogens that have acquired resistance to conventional plant disease control agents.

### DESCRIPTION OF EMBODIMENTS

The oxime-substituted amide compound represented by the formula (I) to be used as active ingredient A of the present invention, has geometric isomers of E-form and Z-form, and the compound to be used as active ingredient A of the present invention is one to encompass such E-form, Z-form or a mixture comprising E-form and Z-form in optional proportions.

Further, the compound represented by the formula (I) to be used as active ingredient A of the present invention, may, depending on its substituents, sometimes have optically active isomers due to the presence of one or more asymmetric carbon atoms, and the compound to be used as active ingredient A of the present invention includes all of such optically active isomers or racemic forms.

In the present specification, the following terms respectively have the following meanings.

The halogen atom includes a fluorine atom, a chlorine atom, a bromine atom and an iodine atom. Further, notation “halo” in this specification also represents these halogen atoms.

Notation “Cₐ-C_{b} alkyl” represents a linear or branched hydrocarbon group having from a to b carbon atoms, and, for example, a methyl group, an ethyl group, a propyl group, an isopropyl group, a butyl group, an isobutyl group, a s-butyl group, a tert-butyl group, a pentyl group, a 1-ethylpropyl group, a 2,2-dimethylpropyl group, a hexyl group, etc. may be mentioned as specific examples, and it is selected within the specified range of the number of carbon atoms.

Here, s- means secondary, tert- means tertiary, respectively, and the same applies hereinafter.

Notation “halo (Cₐ-C_{b}) alkyl” represents a linear or branched hydrocarbon group having from a to b carbon atoms, wherein hydrogen atom(s) bonded to carbon atom(s) is(are) optionally substituted by halogen atom(s), and at that time, if substituted by two or more halogen atoms, such halogen atoms may be the same or different from one another. For example, a fluoromethyl group, a chloromethyl group, a bromomethyl group, an iodomethyl group, a difluoromethyl group, a dichloromethyl group, a trifluoromethyl group, a chlorodifluoromethyl group, a trichloromethyl group, a bromodifluoromethyl group, a 1-fluoroethyl group, a 2-fluoroethyl group, a 2-chloroethyl group, a 2-bromoethyl group, a 2,2-difluoroethyl group, a 2,2,2-trifluoroethyl group, a 2-chloro-2,2-difluoroethyl group, a 2,2,2-trichloroethyl group, a 2-bromo-2,2-difluoroethyl group, a 1,1,2,2-tetrafluoroethyl group, a 2-chloro-1,1,2-trifluoroethyl group, a pentafluoroethyl group, a 2,2-difluoropropyl group, a 3,3,3-trifluoropropyl group, a 3-bromo-3,3-difluoropropyl group, a 2,2,3,3-tetrafluoropropyl group, a 2,2,3,3,3-pentafluoropropyl group, a 1,1,2,3,3,3-hexafluoropropyl group, a heptafluoropropyl group, a 2,2,2-trifluoro-1-(methyl)ethyl group, a 2,2,2-trifluoro-1-(trifluoromethyl)ethyl group, a 1,2,2,2-tetrafluoro-1-(trifluoromethyl)ethyl group, a 2,2,3,4,4,4-hexafluorobutyl group, a 2,2,3,3,4,4,4-heptafluorobutyl group, a nonafluorobutyl group, etc. may be mentioned as specific examples, and it is selected within the specified range of the number of carbon atoms.

Notation “Cₐ-C_{b} cycloalkyl” represents a cyclic hydrocarbon group having from a to b carbon atoms, which may form a monocyclic or composite ring structure of from a three-membered ring to a 10-membered ring. Further, each ring may be optionally substituted by an alkyl group within a specified range of the number of carbon atoms. For example, a cyclopropyl group, a cyclobutyl group, a 1-methylcyclopropyl group, a 2-methylcyclopropyl group, a cyclopentyl group, a 2,2-dimethylcyclopropyl group, a 1-methylcyclobutyl group, a cyclohexyl group, etc. may be mentioned as specific examples, and it is selected within the specified range of the number of carbon atoms.

Notation “Cₐ-C_{b} alkenyl” represents a linear or branched unsaturated hydrocarbon having from a to b carbon atoms and having one or more double bonds in its molecule, and, for example, a vinyl group, a 1-propenyl group, a 2-propenyl group, a 1-methylethenyl group, a 1-butenyl group, a 2-butenyl group, a 1-methyl-1-propenyl group, a 2-methyl-1-propenyl group, a 2-methyl-2-propenyl group, a 3-methyl-3-butenyl group, etc. may be mentioned as specific examples, and it is selected within the specified range of the number of carbon atoms.

Notation “halo (Cₐ-C_{b}) alkenyl” represents a linear or branched unsaturated hydrocarbon having from a to b carbon atoms and having one or more double bonds in its molecule, wherein hydrogen atom(s) bonded to carbon atom(s) is(are) optionally substituted by halogen atom(s). At that time, if substituted by two or more halogen atoms, such halogen atoms may be the same or different from one another. For example, a 2-fluoro-vinyl group, a 2-chloro-vinyl group, a 1,2-dichloro-vinyl group, a 2,2-dichloro-vinyl group, a 2,2-dibromo-vinyl group, a 2-fluoro-2-propenyl group, a 2-chloro-2-propenyl group, a 3-chloro-2-propenyl group, a 3,3-difluoro-2-propenyl group, a 2,3-dichloro-2-propenyl group, a 3,3-dichloro-2-propenyl group, a 2,3,3-trifluoro-2-propenyl group, a 2,3,3-trichloro-2-propenyl group, a 1-(trifluoromethyl)ethenyl group, a 4,4-difluoro-3-butenyl group, a 3,4,4-trifluoro-3-butenyl group, a 2,4,4,4-tetrafluoro-2-butenyl group, a 3-chloro-4,4,4-trifluoro-2-butenyl group, etc. may be mentioned as specific examples, and it is selected within the specified range of the number of carbon atoms.

Notation “Cₐ-C_{b} alkynyl” represents a linear or branched unsaturated hydrocarbon group having from a to b carbon atoms and having one or more triple bonds in its molecule, and, for example, an ethynyl group, a 1-propynyl group, a 2-propynyl group, a 1-butynyl group, a 2-butynyl group, a 3-butynyl group, a 1-methyl-2-propynyl group, a 1-pentynyl group, a 2-pentynyl group, a 1-hexynyl group, a 3-hexynyl group, a 3-methyl-1-pentynyl group, a 4-methyl-1-pentynyl group, a 3,3-dimethyl-1-butynyl group, etc. may be mentioned as specific examples, and it is selected within the specified range of the number of carbon atoms.

Notation “Cₐ-C_{b} cycloalkenyl” represents a cyclic hydrocarbon group having from a to b carbon atoms, which may form a monocyclic or composite ring structure of from a three-membered ring to a 10-membered ring. Further, each ring may be optionally substituted by an alkyl group with a specified range of the number of carbon atoms. For example, a 1-cyclobutenyl group, a 1-methyl-2-cyclobutenyl group, 1-cyclopentenyl group, etc. may be mentioned as specific examples, and it is selected within the specified range of the number of carbon atoms.

Notation “Cₐ-C_{b} alkoxy” represents an alkyl-O— group having from a to b carbon atoms, as defined above, and, for example, a methoxy group, an ethoxy group, a propyloxy group, an isopropyloxy group, a butyloxy group, an iso-butyloxy group, a s-butyloxy group, a tert-butyloxy group, a pentyloxy group, a hexyloxy group, etc. may be mentioned as specific examples, and it is selected within the specified range of the number of carbon atoms.

Notation “halo(Cₐ-C_{b}) alkoxy” represents a haloalkyl-O— group having from a to b carbon atoms, as defined above, and, for example, a difluoromethoxy group, a trifluoromethoxy group, a chlorodifluoromethoxy group, a bromodifluoromethoxy group, a 2-fluoroethoxy group, a 2-chloroethoxy group, a 2,2,2-trifluoroethoxy group, a 1,1,2,2-tetrafluoroethoxy group, a 2-chloro-1,1,2-trifluoroethoxy group, a 1,1,2,3,3,3-hexafluoro-propyloxy group, etc. may be mentioned as specific examples, and it is selected within the specified range of the number of carbon atoms.

Notation “Cₐ-C_{b} alkylthio” represents an alkyl-S— group having from a to b carbon atoms, as defined above, and, for example, a methylthio group, an ethylthio group, a propylthio group, an isopropylthio group, a butylthio group, an isobutylthio group, a s-butylthio group, a tert-butylthio group, etc. may be mentioned as specific examples, and it is selected within the specified range of the number of carbon atoms.

Notation “halo (Cₐ-C_{b}) alkylthio” represents a haloalkyl-S— group having from a to b carbon atoms, as defined above, and, for example, a difluoromethytthio group, a trifluoromethylthio group, a chlorodifluoromethylthio group, a trichloromethylthio group, a bromodifluoromethylthio group, a 2,2,2-trifluoroethyithio group, a 1,1,2,2-tetrafluoroethylthio group, a 2-chloro-1,1,2-trifluoroethylthio group, a pentafluoroethylthio group, a 1,1,2,3,3,3-hexafluoropropylthio group, a heptafluoropropylthio group, a 1,2,2,2-tetrafluoro-1-(trifluoromethyl)ethylthio group, a nonafluorobutylthio group, etc. may be mentioned as specific examples, and it is selected within the specified range of the number of carbon atoms.

Notation “Cₐ-C_{b} alkylsulfinyl” represents an alkyl-S(O)— group having from a to b carbon atoms, as defined above, and, for example, a methylsulfinyl group, an ethylsufinyl group, a propylsulfinyl group, an isopropylsulfinyl group, a butylsulfinyl group, an iso-butylsulfinyl group, a s-butylsufinyl group, a tert-butyisulfinyl group, etc. may be mentioned as specific examples, and it is selected within the specified range of the number of carbon atoms.

Notation “Cₐ-C_{b} alkylsulfonyl” represents an alkyl-S(O)— group having from a to b carbon atoms, as defined above, and, for example, a methylsulfonyl group, an ethylsutfonyl group, a propylsulfonyl group, an isopropylsulfonyl group, a butylsulfonyl group, an iso-butylsulfonyl group, a s-butylsulfonyl group, a tert-butylsulfonyl group, etc. may be mentioned as specific examples, and it is selected within the specified range of the number of carbon atoms.

Notation “Cₐ-C_{b} alkyl sulfonyloxy” represents an alkyl —S(O)₂-O— group having from a to b carbon atoms, as defined above, and, for example, a methylsulfonyloxy group, an ethylsulfonyloxy group, a propylsulfonyloxy group, an isopropylsulfonyloxy group, a butylsulfonyloxy group, an isobutylsulfonyloxy group, a s-butylsulfonyloxy group, a tert-butylsutfonyloxy group, etc. may be mentioned as specific example, and it is selected within the specified range of the number of carbon atoms.

Notation “Cₐ-C_{b} alkylcarbonyl” represents an alkyl-C(O)— group having from a to b carbon atoms, as defined above, and, for example, an acetyl group, a propionyl group, a butyryl group, an isobutyryl group, a valeryl group, an isovaleryl group, a 2-methyl butanoyl group, a pivaloyl group, etc. may be mentioned as specific examples, and it is selected within the specified range of the number of carbon atoms.

Notation “Cₐ-C_{b} alkoxycarbonyl” represents an alkyl-O—C(O)— group having from a to b carbon atoms, as defined above, and, for example, a methoxycarbonyl group, a ethoxycarbonyl group, a propyloxycarbonyl group, an isopropyloxycarbonyl group, a butoxycarbonyl group, an isobutoxycarbonyl group, a tert-butoxycarbonyl group, etc. may be mentioned as specific examples, and it is selected within the specified range of the number of carbon atoms.

Notation “Cₐ-C_{b} alkyl carbonyloxy” represents an alkyl —C(O)—O— group having from a to b carbon atoms, as defined above, and, for example, an acetoxy group, a propionyloxy group, etc. may be mentioned as specific example, and it is selected within the specified range of the number of carbon atoms.

Notation “Cₐ-C_{b} alkoxy(C_{d}-Cₑ) alkyl” represents an alkyl group as defined above, having from d to e carbon atoms, wherein a hydrogen atom bonded to a carbon atom is optionally substituted by an optional Cₐ-C_{b} alkoxy group as defined above, and it is selected within the specified range of the number of carbon atoms.

Notation “(Cₐ-C_{b}) alkyl substituted by R¹⁰” represents an alkyl group having from a to b carbon atoms, as defined above, wherein a hydrogen atom bonded to a carbon atom is substituted by optional R¹⁰, and it is selected within the specified range of the number of carbon atoms.

Notation “hydroxy(C_{d}-Cₑ)cycoalkyl” or “Cₐ-C_{b} alkoxy(C_{d}-Cₑ)cycloalkyl” represents a cycloalkyl group as defined above, having from d to e carbon atoms, wherein a hydrogen atom bonded to a carbon atom is optionally substituted by a hydroxy group or by an optional Cₐ-C_{b} alkoxy group as defined above, respectively, and it is selected within the specified range of the number of carbon atoms.

Notation “(Cₐ-C_{b}) alkynyl substituted by R⁶” represents an alkynyl group as defined above, having from a to b carbon atoms, wherein a hydrogen atom bonded to a carbon atom is substituted by optional R⁶, and it is selected within the specified range of the number of carbon atoms.

Preferred ranges of the respective substituents in the oxime-substituted amide compound represented by the formula (I) to be used as active ingredient A of the present invention, may be optionally combined, and they respectively represent the preferred ranges of compounds to be used as active ingredient A of the present invention.

The oxime-substituted amide compound represented by the formula (I) to be used as active ingredient A in the pesticidal agent composition of the present invention, is a known compound as disclosed in International Patent Application Publication (WO2014/010737), and specifically, compounds listed in Table 1 may be mentioned. However, the compounds in Table 1 are exemplary, and the oxime-substituted amide compound to be used as active ingredient A of the present invention is not limited thereto.

In the following Table 1, Et represents an ethyl group, and hereinafter, n-Pr and Pr-n represent a n-propyl group, i-Pr and Pr-i represent an isopropyl group, c-Pr and Pr-c represent a cyclopropyl group, n-Bu and Bu-n represent a normal butyl group, s-Bu and Bu-s represent a secondary butyl group, t-Bu and Bu-t represent a tertiary butyl group, Pen-c represents a cyclopentyl group, and Ph represents a phenyl group.

Further, notation “-” in the column for the substituent Y⁵ indicates that the corresponding substituent is not present.

Further, notation (R) or (S) in the column for the substituent R² indicates that in the mixing ratio of the optical isomers of the carbon atom to which R² is bonded, (R)-form or (S)-form is at least 90%, respectively.

Furthermore, notation (E) or (Z) in the column for the substituent R¹ indicates that in the mixing ratio of oxime geometric isomers to which the substituent R¹ is bonded, (E)-form or (Z)-form is at least 90%, respectively.

These definitions of terms will apply also to the Tables given hereinafter.

TABLE 1

| | |
|---|---|
| 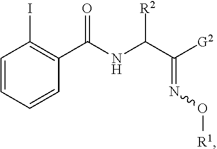 | [I] - 1 |
| 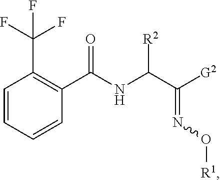 | [I] - 2 |
| 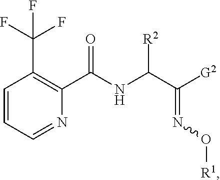 | [I] - 3 |
| 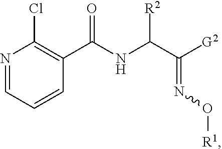 | [I] - 4 |
| 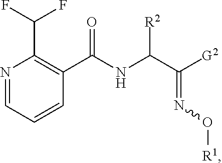 | [I] - 5 |
| 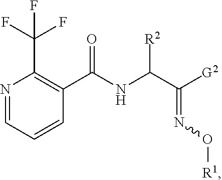 | [I] - 6 |
| 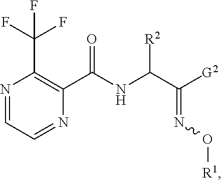 | [I] - 7 |
| 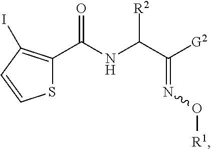 | [I] - 8 |
| 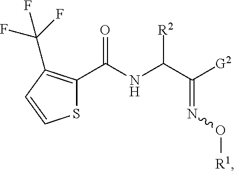 | [I] - 9 |
| 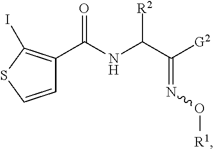 | [I] - 10 |
| 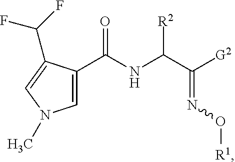 | [I] - 11 |
| 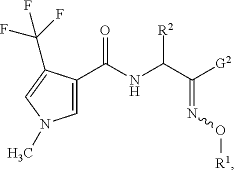 | [I] - 12 |
| 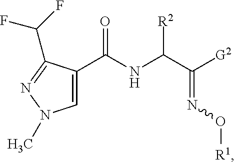 | [I] - 13 |
| 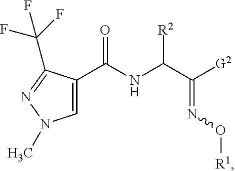 | [I] - 14 |
| 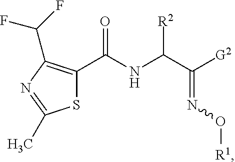 | [I] - 15 |
| 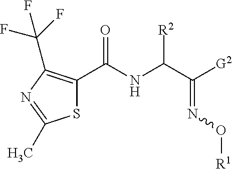 | [I] - 16 |

In the above structural formulae, substituent G² represents the following G²-1 or G²-2.

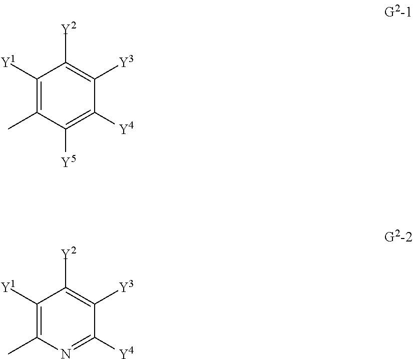

| R² | G² | Y¹ | Y² | Y³ | Y⁴ | Y⁵ | R¹ |
|---|---|---|---|---|---|---|---|
| CH₃ | G²-1 | CL | H | CL | H | H | CH₃ |
| CH₃ | G²-1 | CL | H | CL | H | H | CH₃(E) |
| CH₃(S) | G²-1 | CL | H | CL | H | H | CH₃ |
| CH₃(S) | G²-1 | CL | H | CL | H | H | CH₃(E) |
| CH₃ | G²-1 | CL | H | CL | H | H | Et(E) |
| CH₃(S) | G²-1 | CL | H | CL | H | H | Et(E) |
| CH₃ | G²-1 | CL | H | C≡CCH₃ | H | H | CH₃(E) |
| CH₃(S) | G²-1 | CL | H | C≡CCH₃ | H | H | CH₃(E) |
| CH₃ | G²-1 | CL | H | C≡CCH₃ | H | H | Et(E) |
| CH₃(S) | G²-1 | CL | H | C≡CCH₃ | H | H | Et(E) |
| CH₃ | G²-1 | CL | H | C≡CPr-c | H | H | CH₃(E) |
| CH₃(S) | G²-1 | CL | H | C≡CPr-c | H | H | CH₃(E) |
| H | G²-2 | CL | H | CL | H | — | CH₃ |
| H | G²-2 | CL | H | CL | H | — | CH₃(Z) |
| CH₃ | G²-2 | CL | H | CL | H | — | CH₃(Z) |
| CH₃(S) | G²-2 | CL | H | CL | H | — | CH₃(Z) |
| H | G²-2 | CL | H | CL | H | — | Et |
| H | G²-2 | CL | H | CL | H | — | Et(Z) |
| CH₃ | G²-2 | CL | H | CL | H | — | Et(Z) |
| CH₃(S) | G²-2 | CL | H | CL | H | — | Et(Z) |
| H | G²-2 | CL | H | CL | H | — | n-Pr |
| H | G²-2 | CL | H | CL | H | — | n-Pr(Z) |
| H | G²-2 | CL | H | CL | H | — | i-Pr |
| H | G²-2 | CL | H | CL | H | — | i-Pr(Z) |
| CH₃ | G²-2 | CL | H | CL | H | — | i-Pr |
| CH₃ | G²-2 | CL | H | CL | H | — | i-Pr(Z) |
| CH₃(S) | G²-2 | CL | H | CL | H | — | i-Pr |
| CH₃(S) | G²-2 | CL | H | CL | H | — | i-Pr(Z) |
| H | G²-2 | CL | H | CL | H | — | s-Bu |
| H | G²-2 | CL | H | CL | H | — | s-Bu(Z) |
| H | G²-2 | CL | H | CL | H | — | t-Bu |
| H | G²-2 | CL | H | CL | H | — | t-Bu(Z) |
| H | G²-2 | CL | H | CL | H | — | CH₂CF₃ |
| H | G²-2 | CL | H | CL | H | — | CH₂CF₃(Z) |
| H | G²-2 | CL | H | CL | H | — | CH₂CH═CH₂ |
| H | G²-2 | CL | H | CL | H | — | CH₂CH═CH₂(Z) |
| H | G²-2 | CL | H | CL | H | — | CH₂Ph |
| H | G²-2 | CL | H | CL | H | — | CH₂Ph(Z) |
| H | G²-2 | CL | H | CL | F | — | CH₃(Z) |
| H | G²-2 | CL | H | CL | F | — | Et(Z) |
| H | G²-2 | CL | H | CL | F | — | i-Pr(Z) |
| H | G²-2 | CL | H | Br | H | — | CH₃ |
| H | G²-2 | CL | H | Br | H | — | CH₃(Z) |
| H | G²-2 | CL | H | Br | H | — | Et |
| H | G²-2 | CL | H | Br | H | — | Et(Z) |
| H | G²-2 | CL | H | Br | H | — | i-Pr |
| H | G²-2 | CL | H | Br | H | — | i-Pr(Z) |
| H | G²-2 | CL | H | CF₃ | H | — | CH₃ |
| H | G²-2 | CL | H | CF₃ | H | — | CH₃(Z) |
| H | G²-2 | CL | H | CF₃ | H | — | Et |
| H | G²-2 | CL | H | CF₃ | H | — | Et(Z) |
| H | G²-2 | CL | H | CF₃ | H | — | n-Pr(Z) |
| H | G²-2 | CL | H | CF₃ | H | — | i-Pr |
| H | G²-2 | CL | H | CF₃ | H | — | i-Pr(Z) |
| H | G²-2 | CL | H | CF₃ | H | — | CH₂Pr-c(Z) |
| H | G²-2 | CL | H | CF₃ | H | — | s-Bu |
| H | G²-2 | CL | H | CF₃ | H | — | s-Bu(Z) |
| H | G²-2 | CL | H | CF₃ | H | — | CH(CH₃)CH═CH₂ |
| H | G²-2 | CL | H | CF₃ | H | — | CH(CH₃)CH═CH₂(Z) |
| H | G²-2 | CL | H | C≡CCH₃ | H | — | CH₃ |
| H | G²-2 | CL | H | C≡CCH₃ | H | — | CH₃(Z) |
| H | G²-2 | CL | H | C≡CCH₃ | H | — | Et |
| H | G²-2 | CL | H | C≡CCH₃ | H | — | Et(Z) |
| H | G²-2 | CL | H | C≡CCH₃ | H | — | n-Pr |
| H | G²-2 | CL | H | C≡CCH₃ | H | — | n-Pr(Z) |
| H | G²-2 | CL | H | C≡CCH₃ | H | — | i-Pr |
| H | G²-2 | CL | H | C≡CCH₃ | H | — | i-Pr(Z) |
| H | G²-2 | CL | H | C≡CCH₃ | H | — | s-Bu |
| H | G²-2 | CL | H | C≡CCH₃ | H | — | s-Bu(Z) |
| H | G²-2 | CL | H | C≡CCH₃ | H | — | t-Bu |
| H | G²-2 | CL | H | C≡CCH₃ | H | — | t-Bu(Z) |
| H | G²-2 | CL | H | C≡CPr-c | H | — | CH₃ |
| H | G²-2 | CL | H | C≡CPr-c | H | — | CH₃(Z) |
| H | G²-2 | CL | H | C≡CPr-c | H | — | Et |
| H | G²-2 | CL | H | C≡CPr-c | H | — | Et(Z) |
| H | G²-2 | CL | H | C≡CPr-c | H | — | n-Pr |
| H | G²-2 | CL | H | C≡CPr-c | H | — | n-Pr(Z) |
| H | G²-2 | CL | H | C≡CPr-c | H | — | i-Pr |
| H | G²-2 | CL | H | C≡CPr-c | H | — | i-Pr(Z) |
| H | G²-2 | CL | H | C≡CPr-c | H | — | s-Bu |
| H | G²-2 | CL | H | C≡CPr-c | H | — | s-Bu(Z) |
| H | G²-2 | CL | H | C≡CPr-c | H | — | t-Bu |
| H | G²-2 | CL | H | C≡CPr-c | H | — | t-Bu(Z) |
| H | G²-2 | CL | H | C≡CBu-t | H | — | CH₃ |
| H | G²-2 | CL | H | C≡CBu-t | H | — | CH₃(Z) |
| H | G²-2 | CL | H | C≡CBu-t | H | — | Et |
| H | G²-2 | CL | H | C≡CBu-t | H | — | Et(Z) |
| H | G²-2 | CL | H | C≡CBu-t | H | — | i-Pr |
| H | G²-2 | CL | H | C≡CBu-t | H | — | i-Pr(Z) |
| H | G²-2 | CL | H | C≡CBu-t | H | — | t-Bu(Z) |
| H | G²-2 | CL | H | C≡CSi(CH₃)₃ | H | — | i-Pr |
| H | G²-2 | CL | H | C≡CSi(CH₃)₃ | H | — | i-Pr(Z) |
| H | G²-2 | CL | H | C≡CPh | H | — | i-Pr |
| H | G²-2 | CL | H | C≡CPh | H | — | i-Pr(Z) |
| H | G²-2 | CL | OCH₃ | CL | H | — | CH₃ |
| H | G²-2 | CL | OCH₃ | CL | H | — | CH₃(Z) |
| H | G²-2 | CL | OCH₃ | CL | H | — | Et |
| H | G²-2 | CL | OCH₃ | CL | H | — | Et(Z) |
| H | G²-2 | CL | OCH₃ | CL | H | — | i-Pr |
| H | G²-2 | CL | OCH₃ | CL | H | — | i-Pr(Z) |
| H | G²-2 | CL | OEt | CL | H | — | CH₃(Z) |
| H | G²-2 | CL | OEt | CL | H | — | Et(Z) |
| H | G²-2 | CL | OEt | CL | H | — | i-Pr(Z) |
| H | G²-2 | CL | SCH₃ | CL | H | — | i-Pr |
| H | G²-2 | CL | S(O)CH₃ | CL | H | — | i-Pr |
| H | G²-2 | CL | SO₂CH₃ | CL | H | — | i-Pr |
| H | G²-2 | Br | H | Br | H | — | CH₃ |
| H | G²-2 | Br | H | Br | H | — | CH₃(Z) |
| CH₃ | G²-2 | Br | H | Br | H | — | CH₃(Z) |
| H | G²-2 | Br | H | Br | H | — | Et |
| H | G²-2 | Br | H | Br | H | — | Et(Z) |
| H | G²-2 | Br | H | Br | H | — | i-Pr |
| H | G²-2 | Br | H | Br | H | — | i-Pr(Z) |

In Table 2, more specific examples of the oxime-substituted amide compound represented by the formula (I) to be used as active ingredient A of the present invention, which can be prepared in the same manner as Synthesis Examples disclosed in WO2014/010737 and WO2015/147199, will be shown, but the oxime-substituted amide compound to be used as active ingredient A of the present invention is not limited thereto.

In the Table, “*1” in the column for the melting point means that the property of the compound was oily or resinous.

TABLE 2

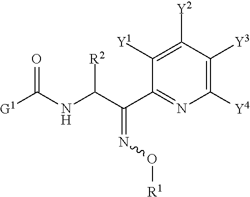

Substituent G¹ represents the following G¹-1a, G¹-3a, G¹-3b, G¹-8a or G¹-9a.

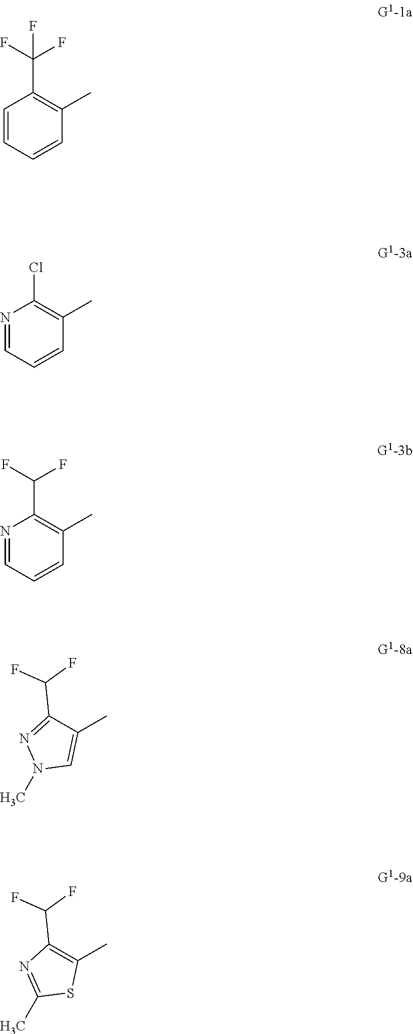

| No. | G¹ | R² | Y¹ | Y² | Y³ | Y⁴ | R¹ | m.p. (° C.) |
|---|---|---|---|---|---|---|---|---|
| 1 | G¹-1a | H | CL | H | CL | H | CH₃ | *1 |
| 2 | G¹-1a | H | CL | H | CL | H | CH₃(Z) | 88-89 |
| 3 | G¹-1a | H | CL | H | CL | H | n-Pr | *1 |
| 4 | G¹-1a | H | CL | H | CL | H | i-Pr(Z) | 109-111 |
| 5 | G¹-3b | H | CL | H | CL | H | i-Pr(Z) | *1 |
| 6 | G¹-1a | CH₃(S) | CL | H | CL | H | i-Pr(Z) | *1 |
| 7 | G¹-1a | H | CL | H | CL | F | Et(Z) | *1 |
| 8 | G¹-1a | H | CL | OCH₃ | CL | H | CH₃(Z) | 74-76 |
| 9 | G¹-1a | H | CL | OCH₃ | CL | H | i-Pr(Z) | 70-71 |
| 10 | G¹-8a | H | CL | OCH₃ | CL | H | i-Pr(Z) | *1 |
| 11 | G¹-1a | H | CL | OEt | CL | H | CH₃(Z) | 90-92 |
| 12 | G¹-1a | H | CL | H | Br | H | CH₃(Z) | 85-86 |
| 13 | G¹-1a | H | CL | H | Br | H | Et(Z) | 101-102 |
| 14 | G¹-1a | H | CL | H | CF₃ | H | i-Pr(Z) | 97-98 |
| 15 | G¹-1a | H | CL | H | CF₃ | H | CH₂Pr-c(Z) | 73-74 |
| 16 | G¹-3b | H | CL | H | C≡CCH₃ | H | Et(Z) | 128-131 |
| 17 | G¹-3b | H | CL | H | C≡CCH₃ | H | n-Pr(Z) | *1 |
| 18 | G¹-1a | H | CL | H | C≡CCH₃ | H | i-Pr(Z) | 106-108 |
| 19 | G¹-3b | H | CL | H | C≡CCH₃ | H | i-Pr(Z) | *1 |
| 20 | G¹-8a | H | CL | H | C≡CCH₃ | H | i-Pr(Z) | 102-103 |
| 21 | G¹-9a | H | CL | H | C≡CCH₃ | H | i-Pr(Z) | *1 |
| 22 | G¹-8a | H | CL | H | C≡CPr-c | H | CH₃ | *1 |
| 23 | G¹-8a | H | CL | H | C≡CPr-c | H | CH₃(Z) | 96-98 |
| 24 | G¹-8a | H | CL | H | C≡CPr-c | H | Et(Z) | 96-98 |
| 25 | G¹-8a | H | CL | H | C≡CPr-c | H | i-Pr(Z) | 105-107 |
| 26 | G¹-1a | H | CL | H | C≡CPr-c | H | s-Bu | *1 |
| 27 | G¹-8a | H | CL | H | C≡CPr-c | H | s-Bu(Z) | *1 |
| 28 | G¹-8a | H | CL | H | C≡CBu-t | H | CH₃(Z) | 132-135 |
| 29 | G¹-1a | H | CL | H | C≡CPh | H | i-Pr | *1 |
| 30 | G¹-3b | H | Br | H | Br | H | i-Pr(Z) | *1 |
| 31 | G¹-8a | H | Br | H | Br | H | i-Pr(Z) | *1 |
| 32 | G¹-1a | H | CL | SO₂CH₃ | CL | H | i-Pr(Z) | *1 |
| 33 | G¹-1a | H | CL | H | CL | H | CH₂CF₃(Z) | 101-103 |
| 34 | G¹-8a | H | CL | H | C≡CCH₃ | H | t-Bu(Z) | 134-140 |
| 35 | G¹-3a | H | CL | H | C≡CBu-t | H | CH₃(Z) | 45-47 |
| 36 | G¹-1a | H | CL | H | C≡CPr-c | H | CH₃(Z) | *1 |
| 37 | G¹-8a | H | CL | H | C≡CBu-t | H | i-Pr(Z) | *1 |

Among oxime-substituted amide compounds of the formula (I) shown in Table 2, ¹H NMR data of compounds, of which the properties were resinous, will be shown in Table 3.

Here, the chemical shift value of the proton nuclear magnetic resonance (¹H NMR) used for the identification of compounds, was measured by using Me₄Si (tetramethylsilane) as the reference substance, at 300 MHz (model: JNM-ECX300 or JNM-ECP300, manufactured by JEOL Ltd.).

Symbols in the proton nuclear magnetic resonance chemical shift values have the following meanings.

s: singlet, d: doublet, t: triplet, q: quartet, sep: septet, dd: double doublet, m: multiplet, br: broad.

TABLE 3

| No. | ¹H NMR (CDCl₃, Me₄Si, 300 MHz) |
|---|---|
| No. 1 | δ8.50 and 8.45 (d, J = 2.1 Hz, 1H), 7.80 and 7.78 (d, J = 2.1 Hz, 1H), 7.35-7.75 |
| | (m, 4H), 6.48 and 6.43 (brs, 1H), 4.73 and 4.53 (d, J = 6.3 Hz, 2H), |
| | 4.06 and 4.02 (s, 3H) |
| No. 3 | δ8.49 and 8.44 (d, J = 2.1 Hz, 1H), 7.80 and 7.78 (d, J = 2.1 Hz, 1H), 7.35-7.7 |
| | (m, 4H), 6.53 and 6.49 (brs, 1H), 4.75 and 4.52 (d, J = 6.3 Hz, 2H), |
| | 4.21 and 4.03 (t, J = 6.9 Hz, 2H), 1.7-1.8 and 1.55-4.65 (m, 2H), 0.96 |
| | and 0.86 (t, J = 7.5 Hz, 3H) |
| No. 5 | δ8.7-8.8 (m, 1H), 8.49 (d, J = 2.1 Hz, 1H), 7.9-8.0 (m, 1H), 7.78 (d, J = |
| | 2.1 Hz, 1H), 7.45-7.55 (m, 1H), 6.8-7.2 (m, 2H), 4.52 (d, J = 5.7 Hz, 2H), |
| | 4.3-4.45 (m, 1H), 1.19 (d, J = 6.0 Hz, 6H) |
| No. 6 | δ8.48 (d, J = 2.1 Hz, 1H), 7.78 (d, J = 2.1 Hz, 1H), 7.45-7.75 (m, 4H), 6.84 |
| | (brs, 1H), 5.15-5.3 (m, 1H), 4.25-4.45 (m, 1H), 1.44 (d, J = 6.6 Hz, |
| | 3H), 1.18 (d, J = 6.0 Hz, 6H) |
| No. 7 | δ7.90 (d, J = 7.8 Hz, 1H), 7.45-7.75 (m, 4H), 6.3-6.45 (m, 1H), 4.52 (d, |
| | J = 4.9 Hz, 2H), 4.14 (q, J = 7.1 Hz, 2H), 1.22 (t, J = 7.1 Hz, 3H) |
| No. 10 | δ8.46 (s, 1H), 7.90 (s, 1H), 7.06 (brs, 1H), 6.84 (t, J = 54.6 Hz, 1H), |
| | 4.48 (d, J = 4.8 Hz, 2H), 4.3-4.45 (m, 1H), 4.03 (s, 3H), 3.93 (s, 3H), |
| | 1.21 (d, J = 6.3 Hz, 6H) |
| No. 17 | δ8.78 (d, J = 4.9 Hz, 1H), 8.51 (d, J = 1.7 Hz, 1H), 7.94 (d, J = 7.8 Hz, 1H), |
| | 7.74 (d, J = 1.7 Hz, 1H), 7.49 (dd, J = 7.8, 4.9 Hz, 1H), 7.03 (t, J = 54.5 |
| | Hz, 1H), 6.85 (brs, 1H), 4.54 (d, J = 5.1 Hz, 2H), 4.05 (t, J = 6.6 Hz, 2H), |
| | 2.10 (s, 3H), 1.55-1.75 (m, 2H), 0.87 (t, J = 7.3 Hz, 3H) |
| No. 19 | δ8.77 (dd, J = 4.8, 1.0 Hz, 1H), 8.50 (d, J = 1.7 Hz, 1H), 7.94 (d, J = 7.8 |
| | Hz, 1H), 7.73 (d, J = 1.7 Hz, 1H), 7.48 (dd, J = 7.8, 4.8 Hz, 1H), 7.03 (t, |
| | J = 54.1 Hz, 1H), 6.93 (brs, 1H), 4.53 (d, J = 5.1 Hz, 2H), 4.37 (sep, J = 6.1 |
| | Hz, 1H), 2.10 (s, 3H), 1.20 (d, J = 6.1 Hz, 6H) |
| No. 21 | δ8.50 (d, J = 1.7 Hz, 1H), 7.72 (d, J = 1.4 Hz, 1H), 7.21 (t, J = 54.0 Hz, 1H), |
| | 7.03 (brs, 1H), 4.48 (d, J = 4.8 Hz, 2H), 4.40 (sep, J = 6.5 Hz, 1H), 2.77 |
| | (s, 3H), 2.10 (s, 3H), 1.22 (d, J = 6.5 Hz, 6H) |
| No. 22 | δ8.47 and 8.45 (s, 1H), 7.88 and 7.85 (s, 1H), 7.65-7.7 (m, 1H), 6.99 |
| | (brs, 1H), 6.87 and 6.75 (t, J = 54.0 Hz, 1H), 4.71 and 4.49 (d, J = 5.1 |
| | Hz, 2H), 3.85-4.1 (m, 6H), 1.4-1.55 (m, 1H), 0.8-1.0 (m, 4H) |
| No. 26 | δ8.48 and 8.42 (d, J = 1.7 Hz, 1H), 7.74 and 7.70 (d, J = 1.7 Hz, 1H), 7.3-7.75 |
| | (m, 4H), 6.60 (brs, 1H), 4.78 and 4.52 (d, J = 4.8 Hz, 2H), 4.1-4.35 |
| | (m, 1H), 1.25-1.7 (m, 3H), 1.17 (d, J = 6.5 Hz, 3H), 0.75-1.0 (m, 4H), |
| | 0.83 (t, J = 7.5 Hz, 3H) |
| No. 27 | δ8.47 (d, J = 1.7 Hz, 1H), 7.90 (s, 1H), 7.68 (d, J = 1.7 Hz, 1H), 7.12 (brs, |
| | 1H), 6.88 (t, J = 54.1 Hz, 1H), 4.48 (d, J = 4.8 Hz, 2H), 4.1-4.25 (m, |
| | 1H), 3.93 (s, 3H), 1.35-1.7 (m, 3H), 1.19 (d, J = 6.5 Hz, 3H), 0.8-1.0 |
| | (m, 4H), 0.84 (t, J = 7.3 Hz, 3H) |
| No. 29 | δ8.65 and 8.59 (d, J = 1.7 Hz, 1H), 7.91 and 7.87 (d, J = 1.7 Hz, 1H), 7.35-7.75 |
| | (m, 9H), 6.59 (brs, 1H), 4.80 and 4.56(d, J = 5.8 and 5.1 Hz, 2H), |
| | 4.54 and 4.38 (sep, J = 6.3 Hz, 1H), 1.34 and 1.19 (d, J = 6.3 Hz, 6H) |
| No. 30 | δ8.7-8.8 (m, 1H), 8.61 (d, J = 1.8 Hz, 1H), 8.05-8.1 (m, 1H), 7.9-8.0 |
| | (m, 1H), 7.4-7.5 (m, 1H), 6.8-7.3 (m, 2H), 4.51 (d, J = 5.4 Hz, 2H), 4.3-4.45 |
| | (m, 1H), 1.20 (d, J = 6.3 Hz, 6H) |
| No. 31 | δ8.61 (d, J = 2.1 Hz, 1H), 8.06 (d, J = 2.1 Hz, 1H), 7.90 (s, 1H), 7.09 (brs, |
| | 1H), 6.85 (t, J = 54.0 Hz, 1H), 4.3-4.5 (m, 3H), 3.92 (s, 3H), 1.21 |
| | (d, J = 6.6 Hz, 6H) |
| No. 32 | δ8.70 and 8.65 (s, 1H), 7.35-7.75 (m, 4H), 6.48 and 6.39 (brs, 1H), |
| | 4.3-4.75 (m, 3H), 3.3-3.4 (m, 3H), 1.1-1.35 (m, 6H) |
| No. 36 | δ8.46 and 8.42 (d, J = 1.8 Hz, 1H), 7.45-7.75 (m, 5H), 6.45-6.65 (m, 1H), |
| | 4.74 and 4.52 (d, J = 5.1 Hz, 2H), 4.06 and 3.86 (s, 3H), 1.4-1.55 (m, |
| | 1H), 0.8-1.0 (m, 4H) |
| No. 37 | δ8.50 (d, J = 2.1 Hz, 1H), 7.91 (s, 1H), 7.72 (d, J = 2.1 Hz, 1H), 7.14 (brs, |
| | 1H), 6.88 (t, J = 54.0 Hz, 1H), 4.49 (d, J = 4.5 Hz, 2H), 4.39 (sep, J = |
| | 6.3 Hz, 1H), 3.94 (s, 3H), 1.33 (s, 9H), 1.20 (d, J = 6.3 Hz, 6H ) |

As the known fungicidal or bactericidal active compound to be used as active ingredient B of the present invention, for example, compound(s) selected from each of the following groups may be mentioned.

Active Ingredient B-I Group:

TABLE 4

| NO. | Compound name (common name) |
|---|---|
| C49 | pydiflumetofen |
| C50 | pyraziflumid |
| C51 | 1-(2-[([1-(4-chlorophenyl)-1H-pyrazol-3-yl]oxy)-methyl]- |
| | 3-methylphenyl)-4-methyl-1,4-dihydro-5H-tetrazol-5-one |

Active Ingredient B-II Group;

TABLE 5

| NO. | Compound name (common name) |
|---|---|
| H50 | fenpyrazamine |

Active Ingredient B-III Group;

TABLE 6

| NO. | Compound name (common name) |
|---|---|
| A05 | metalaxyl-M |
| A07 | oxadixyl |
| A10 | hymexazol |

Active Ingredient B-IV Group;

TABLE 7

| NO. | Compound name (common name) |
|---|---|
| B02 | carbendazim |
| B08 | zoxamide |

Active ingredient B-V group;

TABLE 8

| NO. | Compound name (common name) |
|---|---|
| C22 | enoxastrobin |
| C25 | fenaminstrobin |
| C38 | triclopyricarb |
| C41 | cyazofamid |

Active ingredient B-VI group;

TABLE 9

| NO. | Compound name (common name) |
|---|---|
| D05 | kasugamycin |
| D06 | streptomycin |

Active ingredient B-VII group;

TABLE 10

| NO. | Compound name (common name) |
|---|---|
| G12 | propamocarb hydrochloride |
| G13 | Bacillus subtilis D747 strain |

Active ingredient B-VIII group;

TABLE 11

| NO. | Compound name (common name) |
|---|---|
| H21 | imibenconazole |
| H30 | propiconazole |
| H33 | pyrisoxazole |
| H37 | triadimefon |
| H39 | triflumizole |

Active ingredient B-IX group;

TABLE 12

| NO. | Compound name (common name) |
|---|---|
| H51 | mefentrifluconazole |

Active ingredient B-X group;

TABLE 13

| NO. | Compound name (common name) |
|---|---|
| I01 | validamycin |
| I05 | dimethomorph |
| I08 | mandipropamid |

Active ingredient B-XI group;

TABLE 14

| NO. | Compound name (common name) |
|---|---|
| L08 | copper oxychloride |
| L10 | basic copper sulfate |
| L21 | thiram |

Active ingredient B-XII group;

TABLE 15

| NO. | Compound name (common name) |
|---|---|
| L35 | zineb |

Active ingredient B-XIII group;

TABLE 16

| NO. | Compound name (common name) |
|---|---|
| M02 | cymoxanil |
| M08 | fosetyl-aluminium |

Active ingredient B-XIV group;

TABLE 17

| NO. | Compound name (common name) |
|---|---|
| M20 | quinofumelin |
| M21 | 2-(2-[(7,8-difluoro-2-methylquinolin-3-yl)oxy]-6-fluoro- |
| | phenyl)propan-2-ol |
| M23 | dipymetitrone |
| M34 | ethylicin |
| M44 | 3-chloro-4-(2,6-difluorophenyl)-6-methyl-5-phenyl-pyridazine |

Active ingredient B-XV group;

TABLE 18

| NO. | Compound name (common name) |
|---|---|
| M32 | dimetachlone |
| M33 | zhongshengmycin |
| M36 | thiodiazole-copper |
| M37 | zinc thiazole |
| M38 | fenaminosulf |
| M40 | wuyiencin |
| M41 | ningnanmycin |
| M42 | berberine |
| M43 | copper(I) oxide |

The compound No. C51 is a compound disclosed in WO2013/162072, the compound No. M21 is a compound disclosed in WO2011/081174, and the compound No. M44 is a compound disclosed in WO20121020772.

Now, examples of the combination of [active ingredient A] selected from oxime-substituted amide compounds represented by the formula (I) and [active ingredient B] selected from fungicidal or bactericidal compounds, which exhibits a synergistic disease controlling effect, will be given below. In the following notations, for example, notation “1+(C49)” represents a combination of active ingredient A being the compound of No. 1 in Table 2, and active ingredient B being pydiflumetofen of No. C₄₉ in Table 4.

Examples of the combination of compounds: 1+(A05), 1+(A07), 1+(A10), 1+(B02), 1+(B08), 1+(C22), 1+(C25), 1+(C38), 1+(C41), 1+(C49), I+(C50), 1+(C51), 1+(D05), I+(D06), 1+(G12), 1+(G13), 1+(H21), 1+(H30), 1+(H33), I+(H37), 1+(H39), I+(H50), I+(H51), 1+(I01), 1+(I05), 1+(I08), 1+(L08), 1+(L10), 1+(L21), 1+(L35), 1+(M02), 1+(M08), 1+(M20), 1+(M21), 1+(M23), 1+(M32), 1+(M33), 1+(M34), 1+(M36), 1+(M37), 1+(M38), 1+(M40), 1+(M41), 1+(M42), 1+(M43), 1+(M44), 2+(A05), 2+(A07), 2+(A10), 2+(B02), 2+(B08), 2+(C22), 2+(C25), 2+(C38), 2+(C41), 2+(C49), 2+(C50), 2+(C51), 2+(D05), 2+(D06), 2+(G12), 2+(G13), 2+(H21), 2+(H30), 2+(H33), 2+(H37), 2+(H39), 2+(H50), 2+(H51), 2+(I01), 2+(I05), 2+(I08), 2+(L08), 2+(L10), 2+(L21), 2+(L35), 2+(M02), 2+(M08), 2+(M20), 2+(M21), 2+(M23), 2+(M32), 2+(M33), 2+(M34), 2+(M36), 2+(M37), 2+(M38), 2+(M40), 2+(M41), 2+(M42), 2+(M43), 2+(M44), 3+(A05), 3+(A07), 3+(A10), 3+(B02), 3+(B08), 3+(C22), 3+(C25), 3+(C38), 3+(C41), 3+(C49), 3+(C50), 3+(C51), 3+(D05), 3+(D06), 3+(G12), 3+(G13), 3+(H21), 3+(H30), 3+(H33), 3+(H37), 3+(H39), 3+(H50), 3+(H51), 3+(I01), 3+(I05), 3+(I08), 3+(L08), 3+(L10), 3+(L21), 3+(L35), 3+(M02), 3+(M08), 3+(M20), 3+(M21), 3+(M23), 3+(M32), 3+(M33), 3+(M34), 3+(M36), 3+(M37), 3+(M38), 3+(M40), 3+(M41), 3+(M42), 3+(M43), 3+(M44), 4+(A05), 4+(A07), 4+(A10), 4+(802), 4+(B08), 4+(C22), 4+(C25), 4+(C38), 4+(C41), 4+(C49), 4+(C50), 4+(C51), 4+(D05), 4+(D06), 4+(G12), 4+(G13), 4+(H21), 4+(H30), 4+(H33), 4+(H37), 4+(H39), 4+(H50), 4+(H51), 4+(I01), 4+(I05), 4+(I08), 4+(L08), 4+(L10), 4+(L21), 4+(L35), 4+(M02), 4+(M08), 4+(M20), 4+(M21), 4+(M23), 4+(M32), 4+(M33), 4+(M34), 4+(M36), 4+(M37), 4+(M38), 4+(M40), 4+(M41), 4+(M42), 4+(M43), 4+(M44), 5+(A05), 5+(A07), 5+(A10), 5+(B02), 5+(B08), 5+(C22), 5+(C25), 5+(C38), 5+(C41), 5+(C49), 5+(C50), 5+(051), 5+(D05), 5+(D06), 5+(G12), 5+(G13), 5+(H21), 5+(H30), 5+(H33), 5+(H37), 5+(H39), 5+(H50), 5+(H51), 5+(I01), 5+(I05), 5+(I08), 5+(L08), 5+(L10), 5+(L21), 5+(L35), 5+(M02), 5+(M08), 5+(M20), 5+(M21), 5+(M23), 5+(M32), 5+(M33), 5+(M34), 5+(M36), 5+(M37), 5+(M38), 5+(M40), 5+(M41), 5+(M42), 5+(M43), 5+(M44), 6+(A05), 6+(A07), 6+(A10), 6+(B02), 6+(B08), 6+(C22), 6+(C25), 6+(C38), 6+(C41), 6+(C49), 6+(050), 6+(C51), 6+(D05), 6+(D06), 6+(G12), 6+(G13), 6+(H21), 6+(H30), 6+(H33), 6+(H37), 6+(H39), 6+(H50), 6+(H51), 6+(I01), 6+(I05), 6+(I08), 6+(L08), 6+(L10), 6+(L21), 6+(L35), 6+(M02), 6+(M08), 6+(M20), 6+(M21), 6+(M23), 6+(M32), 6+(M33), 6+(M34), 6+(M36), 6+(M37), 6+(M38), 6+(M40), 6+(M41), 6+(M42), 6+(M43), 6+(M44), 7+(A05), 7+(A07), 7+(A10), 7+(B02), 7+(B08), 7+(C22), 7+(C25), 7+(C38), 7+(C41), 7+(C49), 7+(C50), 7+(C51), 7+(D05), 7+(D06), 7+(G12), 7+(G13), 7+(H21), 7+(H30), 7+(H33), 7+(H37), 7+(H39), 7+(H50), 7+(H51), 7+(I01), 7+(I05), 7+(I08), 7+(L08), 7+(L10), 7+(L21), 7+(L35), 7+(M02), 7+(M08), 7+(M20), 7+(M21), 7+(M23), 7+(M32), 7+(M33), 7+(M34), 7+(M36), 7+(M37), 7+(M38), 7+(M40), 7+(M41), 7+(M42), 7+(M43), 7+(M44), 8+(A05), 8+(A07), 8+(A10), 8+(B02), 8+(B08), 8+(C22), 8+(C25), 8+(C38), 8+(C41), 8+(C49), 8+(C50), 8+(C51), 8+(D05), 8+(D06), 8+(G12), 8+(G13), 8+(H21), 8+(H30), 8+(H33), 8+(H37), 8+(H39), 8+(H50), 8+(H51), 8+(I01), 8+(I05), 8+(I08), 8+(L08), 8+(L10), 8+(L21), 8+(L35), 8+(M02), 8+(M08), 8+(M20), 8+(M21), 8+(M23), 8+(M32), 8+(M33), 8+(M34), 8+(M36), 8+(M37), 8+(M38), 8+(M40), 8+(M41), 8+(M42), 8+(M43), 8+(M44), 9+(A05), 9+(A07), 9+(A10), 9+(B02), 9+(B08), 9+(C22), 9+(C25), 9+(C38), 9+(C41), 9+(C49), 9+(C50), 9+(C51), 9+(D05), 9+(D06), 9+(G12), 9+(G13), 9+(H21), 9+(H30), 9+(H33), 9+(H37), 9+(H39), 9+(H50), 9+(H51), 9+(I01), 9+(I05), 9+(I08), 9+(L08), 9+(L10), 9+(L21), 9+(L35), 9+(M02), 9+(M08), 9+(M20), 9+(M21), 9+(M23), 9+(M32), 9+(M33), 9+(M34), 9+(M36), 9+(M37), 9+(M38), 9+(M40), 9+(M41), 9+(M42), 9+(M43), 9+(M44), 10+(A05), 10+(A07), 10+(A10), 10+(B02), 10+(B08), 10+(C22), 10+(C25), 10+(C38), 10+(C41), 10+(C49), 10+(C50), 10+(C51), 10+(D05), 10+(D06), 10+(G12), 10+(G13), 10+(H21), 10+(H30), 10+(H33), 10+(H37), 10+(H39), 10+(H50), 10+(H51), 10+(I01), 10+(I05), 10+(08), 10+(L08), 10+(L10), 10+(L21), 10+(L35), 10+(M02), 10+(M08), 10+(M20), 10+(M21), 10+(M23), 10+(M32), 10+(M33), 10+(M34), 10+(M36), 10+(M37), 10+(M38), 10+(M40), 10+(M41), 10+(M42), 10+(M43), 10+(M44), 11+(A05), 1l+(A07), 11+(A10), 11+(B02), I1+(B08), 11+(C22), 11+(C25), 11+(C38), 11+(C41), 11+(C49), 11+(C50), 11+(C51), 11+(D05), 11+(D06), 11+(G12), 11+(G13), 11+(H21), I1+(H30), 11+(H33), 11+(H37), 11+(H39), 11+(H50), 11+(H51), 11+(I01), 11+(I05), 11+(I08), 11+(L08), 11+(L10), 11+(L21), 11+(L35), 11+(M02), l1+(M08), 11+(M20), 1l+(M21), 11+(M23), 11+(M32), 11+(M33), 11+(M34), 11+(M36), 11+(M37), 11+(M38), 11+(M40), 11+(M41), 11+(M42), 11+(M43), l11+(M44), 12+(A05), 12+(A07), 12+(A10), 12+(802), 12+(B08), 12+(C22), 12+(C25), 12+(C38), 12+(C41), 12+(C49), 12+(C50), 12+(C51), 12+(D05), 12+(D06), 12+(G12), 12+(G13), 12+(H21), 12+(H30), 12+(H33), 12+(H37), 12+(H39), 12+(H50), 12+(H51), 12+(I01), 12+(I05), 12+(I08), 12+(L08), 12+(L10), 12+(L21), 12+(L35), 12+(M02), 12+(M08), I2+(M20), 12+(M21), 12+(M23), 12+(M32), 12+(M33), 12+(M34), 12+(M36), 12+(M37), 12+(M38), 12+(M40), 12+(M41), 12+(M42), 12+(M43), 12+(M44), 13+(A05), 13+(A07), 13+(A10), 13+(B02), 13+(B08), 13+(C22), 13+(C25), 13+(C38), 13+(C41), 13+(C49), 13+(C50), 13+(C51), 13+(D05), 13+(D06), 13+(G12), 13+(G13), 13+(H21), 13+(H30), 13+(H33), 13+(H37), 13+(H39), 13+(H50), 13+(H51), 13+(I01), 13+(I05), 13+(I08), 13+(L08), 13+(L10), 13+(L21), 13+(L35), 13+(M02), 13+(M08), 13+(M20), 13+(M21), 13+(M23), 13+(M32), 13+(M33), 13+(M34), 13+(M36), 13+(M37), 13+(M38), 13+(M40), 13+(M41), 13+(M42), 13+(M43), 13+(M44), 14+(A05), 14+(A07), 14+(A10), 14+(B02), 14+(B08), 14+(C22), 14+(C25), 14+(C38), 14+(C41), 14+(C49), 14+(C50), 14+(C51), 14+(D05), 14+(D06), 14+(G12), 14+(G13), 14+(H21), 14+(H30), 14+(H33), 14+(H37), 14+(H39), 14+(H50), 14+(H51), 14+(I01), 14+(I05), 14+(I08), 14+(L08), 14+(L10), 14+(L21), 14+(L35), 14+(M02), 14+(M08), 14+(M20), 14+(M21), 14+(M23), 14+(M32), 14+(M33), 14+(M34), 14+(M36), 14+(M37), 14+(M38), 14+(M40), 14+(M41), 14+(M42), 14+(M43), 14+(M44), 15+(A05), 15+(A07), 15+(A10), 15+(B02), 15+(B08), 15+(C22), 15+(C25), 15+(C38), 15+(C41), 15+(C49), 15+(C50), 15+(C51), 15+(D05), 15+(D06), 15+(G12), 15+(G13), 15+(H21), 15+(H30), 15+(H33), 15+(H37), 15+(H39), 15+(H50), 15+(H51), 15+(I01), 15+(I05), 15+(I08), 15+(L08), 15+(L10), 15+(L21), 15+(L35), 15+(M02), 15+(M08), 15+(M20), 15+(M21), 15+(M23), 15+(M32), 15+(M33), 15+(M34), 15+(M36), 15+(M37), 15+(M38), 15+(M40), 15+(M41), 15+(M42), 15+(M43), 15+(M44), 16+(A05), 16+(A07), 16+(A10), 16+(B02), 16+(B08), 16+(C22), 16+(C25), 16+(C38), 16+(C41), 16+(C49), 16+(C50), 16+(C51), 16+(D05), 16+(D06), 16+(G12), 16+(G13), 16+(H21), 16+(H30), 16+(H33), 16+(H37), 16+(H39), 16+(H50), 16+(H51), 16+(I01), 16+(I05), 16+(I08), 16+(L08), 16+(L10), 16+(L21), 16+(L35), 16+(M02), 16+(M08), 16+(M20), 16+(M21), 16+(M23), 16+(M32), 16+(M33), 16+(M34), 16+(M36), 16+(M37), 16+(M38), 16+(M40), 16+(M41), 16+(M42), 16+(M43), 16+(M44), 17+(A05), 17+(A07), 17+(A10), 17+(B02), 17+(B08), 17+(C22), 17+(C25), 17+(C38), 17+(C41), 17+(C49), 17+(C50), 17+(C51), 17+(D05), 17+(D06), 17+(G12), 17+(G13), 17+(H21), 17+(H30), 17+(H33), 17+(H37), 17+(H39), 17+(H50), 17+(H51), 17+(I01), 17+(I05), 17+(I08), 17+(L08), 17+(L10), 17+(L21), 17+(L35), 17+(M02), 17+(M08), 17+(M20), 17+(M21), 17+(M23), 17+(M32), 17+(M33), 17+(M34), 17+(M36), 17+(M37), 17+(M38), 17+(M40), 17+(M41), 17+(M42), 17+(M43), 17+(M44), 18+(A05), 18+(A07), 18+(A10), 18+(B02), 18+(B08), 18+(C22), 18+(C25), 18+(C38), 18+(C41), 18+(C49), 18+(C50), 18+(C51), 18+(D05), 18+(D06), 18+(G12), 18+(G13), 18+(H21), 18+(H30), 18+(H33), 18+(H37), 18+(H39), 18+(H50), 18+(H51), 18+(I01), 18+(I05), 18+(I08), 18+(L08), 18+(L10), 18+(L21), 18+(L35), 18+(M02), 18+(M08), 18+(M20), 18+(M21), 18+(M23), 18+(M32), 18+(M33), 18+(M34), 18+(M36), 18+(M37), 18+(M38), 18+(M40), 18+(M41), 18+(M42), 18+(M43), 18+(M44), 19+(A05), 19+(A07), 19+(A10), 19+(B02), 19+(B08), 19+(C22), 19+(C25), 19+(C38), 19+(C41), 19+(C49), 19+(C50), 19+(C51), 19+(D05), 19+(D06), 19+(G12), 19+(G13), 19+(H21), 19+(H30), 19+(H33), 19+(H37), 19+(H39), 19+(H50), 19+(H51), 19+(I01), 19+(I05), 19+(I08), 19+(L08), 19+(L10), 19+(L21), 19+(L35), 19+(M02), 19+(M08), 19+(M20), 19+(M21), 19+(M23), 19+(M32), 19+(M33), 19+(M34), 19+(M36), 19+(M37), 19+(M38), 19+(M40), 19+(M41), 19+(M42), 19+(M43), 19+(M44), 20+(A05), 20+(A07), 20+(A10), 20+(B02), 20+(B08), 20+(C22), 20+(C25), 20+(C38), 20+(C41), 20+(C49), 20+(C50), 20+(C51), 20+(D05), 20+(D06), 20+(G12), 20+(G13), 20+(H21), 20+(H30), 20+(H33), 20+(H37), 20+(H39), 20+(H50), 20+(H51), 20+(I01), 20+(I05), 20+(I08), 20+(L08), 20+(L10), 20+(L21), 20+(L35), 20+(M02), 20+(M08), 20+(M20), 20+(M21), 20+(M23), 20+(M32), 20+(M33), 20+(M34), 20+(M36), 20+(M37), 20+(M38), 20+(M40), 20+(M41), 20+(M42), 20+(M43), 20+(M44), 21+(A05), 21+(A07), 21+(A10), 21+(B02), 21+(B08), 21+(C22), 21+(C25), 21+(C38), 21+(C41), 21+(C49), 21+(C50), 21+(C51), 21+(D05), 21+(D06), 21+(G12), 21+(G13), 21+(H21), 21+(H30), 21+(H33), 21+(H37), 21+(H39), 21+(H50), 21+(H51), 21+(I01), 21+(I05), 21+(I08), 21+(L08), 21+(L10), 21+(L21), 21+(L35), 21+(M02), 21+(M08), 21+(M20), 21+(M21), 21+(M23), 21+(M32), 21+(M33), 21+(M34), 21+(M36), 21+(M37), 21+(M38), 21+(M40), 21+(M41), 21+(M42), 21+(M43), 21+(M44), 22+(A05), 22+(A07), 22+(A10), 22+(B02), 22+(B08), 22+(C22), 22+(C25), 22+(C38), 22+(C41), 22+(C49), 22+(C50), 22+(C51), 22+(D05), 22+(D06), 22+(G12), 22+(G13), 22+(H21), 22+(H30), 22+(H33), 22+(H37), 22+(H39), 22+(H50), 22+(H51), 22+(I41), 22+(I05), 22+(I08), 22+(L08), 22+(L10), 22+(L21), 22+(L35), 22+(M02), 22+(M08), 22+(M20), 22+(M21), 22+(M23), 22+(M32), 22+(M33), 22+(M34), 22+(M36), 22+(M37), 22+(M38), 22+(M40), 22+(M41), 22+(M42), 22+(M43), 22+(M44), 23+(A05), 23+(A07), 23+(A10), 23+(B02), 23+(B08), 23+(C22), 23+(C25), 23+(C38), 23+(C41), 23+(C49), 23+(C50), 23+(C51), 23+(D05), 23+(D06), 23+(G12), 23+(G13), 23+(H21), 23+(H30), 23+(H33), 23+(H37), 23+(H39), 23+(H50), 23+(H51), 23+(I01), 23+(I05), 23+(I08), 23+(L08), 23+(L10), 23+(L21), 23+(L35), 23+(M02), 23+(M08), 23+(M20), 23+(M21), 23+(M23), 23+(M32), 23+(M33), 23+(M34), 23+(M36), 23+(M37), 23+(M38), 23+(M40), 23+(M41), 23+(M42), 23+(M43), 23+(M44), 24+(A05), 24+(A07), 24+(A10), 24+(B02), 24+(B08), 24+(C22), 24+(C25), 24+(C38), 24+(C41), 24+(C49), 24+(050), 24+(C51), 24+(D05), 24+(D06), 24+(G12), 24+(G13), 24+(H21), 24+(H30), 24+(H33), 24+(H37), 24+(H39), 24+(H50), 24+(H51), 24+(I1), 24+(I05), 24+(I08), 24+(L08), 24+(L10), 24+(L21), 24+(L35), 24+(M02), 24+(M08), 24+(M20), 24+(M21), 24+(M23), 24+(M32), 24+(M33), 24+(M34), 24+(M36), 24+(M37), 24+(M38), 24+(M40), 24+(M41), 24+(M42), 24+(M43), 24+(M44), 25+(A05), 25+(A07), 25+(A10), 25+(B02), 25+(B08), 25+(C22), 25+(C25), 25+(C38), 25+(C41), 25+(C49), 25+(C50), 25+(C51), 25+(D05), 25+(D06), 25+(G12), 25+(G13), 25+(H21), 25+(H30), 25+(H33), 25+(H37), 25+(H39), 25+(H50), 25+(H51), 25+(I01), 25+(I05), 25+(I08), 25+(L08), 25+(L10), 25+(L21), 25+(L35), 25+(M02), 25+(M08), 25+(M20), 25+(M21), 25+(M23), 25+(M32), 25+(M33), 25+(M34), 25+(M36), 25+(M37), 25+(M38), 25+(M40), 25+(M41), 25+(M42), 25+(M43), 25+(M44), 26+(A05), 26+(A07), 26+(A10), 26+(B02), 26+(B08), 26+(C22), 26+(C25), 26+(C38), 26+(C41), 26+(C49), 26+(C50), 26+(C51), 26+(D05), 26+(D06), 26+(G12), 26+(G13), 26+(H21), 26+(H30), 26+(H33), 26+(H37), 26+(H39), 26+(H50), 26+(H51), 26+(I01), 26+(I05), 26+(I08), 26+(L08), 26+(L10), 26+(L21), 26+(L35), 26+(M02), 26+(M08), 26+(M20), 26+(M21), 26+(M23), 26+(M32), 26+(M33), 26+(M34), 26+(M36), 26+(M37), 26+(M38), 26+(M40), 26+(M41), 26+(M42), 26+(M43), 26+(M44), 27+(A05), 27+(A07), 27+(A10), 27+(B02), 27+(B08), 27+(C22), 27+(C25), 27+(C38), 27+(C41), 27+(C49), 27+(C50), 27+(C51), 27+(D05), 27+(D06), 27+(G12), 27+(G13), 27+(H21), 27+(H30), 27+(H33), 27+(H37), 27+(H39), 27+(H50), 27+(H51), 27+(I01), 27+(I05), 27+(I08), 27+(L08), 27+(L10), 27+(L21), 27+(L35), 27+(M02), 27+(M08), 27+(M20), 27+(M21), 27+(M23), 27+(M32), 27+(M33), 27+(M34), 27+(M36), 27+(M37), 27+(M38), 27+(M40), 27+(M41), 27+(M42), 27+(M43), 27+(M44), 28+(A05), 28+(A07), 28+(A10), 28+(B02), 28+(B08), 28+(C22), 28+(C25), 28+(C38), 28+(C41), 28+(C49), 28+(C50), 28+(C51), 28+(D05), 28+(D06), 28+(G12), 28+(G13), 28+(H21), 28+(H30), 28+(H33), 28+(H37), 28+(H39), 28+(H50), 28+(H51), 28+(I01), 28+(I05), 28+(I08), 28+(L08), 28+(L10), 28+(L21), 28+(L35), 28+(M02), 28+(M08), 28+(M20), 28+(M21), 28+(M23), 28+(M32), 28+(M33), 28+(M34), 28+(M36), 28+(M37), 28+(M38), 28+(M40), 28+(M41), 28+(M42), 28+(M43), 28+(M44), 29+(A05), 29+(A07), 29+(A10), 29+(B02), 29+(B08), 29+(C22), 29+(C25), 29+(C38), 29+(C41), 29+(C49), 29+(C50), 29+(C51), 29+(D05), 29+(D06), 29+(G12), 29+(G13), 29+(H21), 29+(H30), 29+(H33), 29+(H37), 29+(H39), 29+(H50), 29+(H51), 29+(I01), 29+(I05), 29+(I08), 29+(L08), 29+(L10), 29+(L21), 29+(L35), 29+(M02), 29+(M08), 29+(M20), 29+(M21), 29+(M23), 29+(M32), 29+(M33), 29+(M34), 29+(M36), 29+(M37), 29+(M38), 29+(M40), 29+(M41), 29+(M42), 29+(M43), 29+(M44), 30+(A05), 30+(A07), 30+(A10), 30+(B02), 30+(B08), 30+(C22), 30+(C25), 30+(C38), 30+(C41), 30+(C49), 30+(C50), 30+(C51), 30+(D05), 30+(D06), 30+(G12), 30+(G13), 30+(H21), 30+(H30), 30+(H33), 30+(H37), 30+(H39), 30+(H50), 30+(H51), 30+(I01), 30+(I05), 30+(I08), 30+(L08), 30+(L10), 30+(L21), 30+(L35), 30+(M02), 30+(M08), 30+(M20), 30+(M21), 30+(M23), 30+(M32), 30+(M33), 30+(M34), 30+(M36), 30+(M37), 30+(M38), 30+(M40), 30+(M41), 30+(M42), 30+(M43), 30+(M44), 31+(A05), 31+(A07), 31+(A10), 31+(B02), 31+(808), 31+(C22), 31+(C25), 31+(C38), 31+(C41), 31+(C49), 31+(C50), 31+(C51), 31+(D05), 31+(D06), 31+(G12), 31+(G13), 31+(H21), 31+(H30), 31+(H33), 31+(H37), 31+(H39), 31+(H50), 31+(H51), 31+(I01), 31+(I05), 31+(I08), 31+(L08), 31+(L10), 31+(L21), 31+(L35), 31+(M02), 31+(M08), 31+(M20), 31+(M21), 31+(M23), 31+(M32), 31+(M33), 31+(M34), 31+(M36), 31+(M37), 31+(M38), 31+(M40), 31+(M41), 31+(M42), 31+(M43), 31+(M44), 32+(A05), 32+(A07), 32+(A10), 32+(B02), 32+(B08), 32+(C22), 32+(C25), 32+(C38), 32+(C41), 32+(C49), 32+(C50), 32+(C51), 32+(D05), 32+(D06), 32+(G12), 32+(G13), 32+(H21), 32+(H30), 32+(H33), 32+(H37), 32+(H39), 32+(H50), 32+(H51), 32+(I01), 32+(I05), 32+(I08), 32+(L08), 32+(L10), 32+(L21), 32+(L35), 32+(M02), 32+(M08), 32+(M20), 32+(M21), 32+(M23), 32+(M32), 32+(M33), 32+(M34), 32+(M36), 32+(M37), 32+(M38), 32+(M40), 32+(M41), 32+(M42), 32+(M43), 32+(M44), 33+(A05), 33+(A07), 33+(A10), 33+(B02), 33+(B08), 33+(C22), 33+(C25), 33+(C38), 33+(C41), 33+(C49), 33+(C50), 33+(C51), 33+(D05), 33+(D06), 33+(G12), 33+(G13), 33+(H21), 33+(H30), 33+(H33), 33+(H37), 33+(H39), 33+(H50), 33+(H51), 33+(I01), 33+(I05), 33+(I08), 33+(L08), 33+(L10), 33+(L21), 33+(L35), 33+(M02), 33+(M08), 33+(M20), 33+(M21), 33+(M23), 33+(M32), 33+(M33), 33+(M34), 33+(M36), 33+(M37), 33+(M38), 33+(M40), 33+(M41), 33+(M42), 33+(M43), 33+(M44), 34+(A05), 34+(A07), 34+(A10), 34+(B02), 34+(B08), 34+(C22), 34+(C25), 34+(C38), 34+(C41), 34+(C49), 34+(C50), 34+(C51), 34+(D05), 34+(D06), 34+(G12), 34+(G13), 34+(H21), 34+(H30), 34+(H33), 34+(H37), 34+(H39), 34+(H50), 34+(H51), 34+(I01), 34+(I05), 34+(I08), 34+(L08), 34+(L10), 34+(L21), 34+(L35), 34+(M02), 34+(M08), 34+(M20), 34+(M21), 34+(M23), 34+(M32), 34+(M33), 34+(M34), 34+(M36), 34+(M37), 34+(M38), 34+(M40), 34+(M41), 34+(M42), 34+(M43), 34+(M44), 35+(A05), 35+(A07), 35+(A10), 35+(B02), 35+(B08), 35+(C22), 35+(C25), 35+(C38), 35+(C41), 35+(C49), 35+(C50), 35+(C51), 35+(D05), 35+(D06), 35+(G12), 35+(G13), 35+(H21), 35+(H30), 35+(H33), 35+(H37), 35+(H39), 35+(H50), 35+(H51), 35+(I01), 35+(I05), 35+(I08), 35+(L08), 35+(L10), 35+(L21), 35+(L35), 35+(M02), 35+(M08), 35+(M20), 35+(M21), 35+(M23), 35+(M32), 35+(M33), 35+(M34), 35+(M36), 35+(M37), 35+(M38), 35+(M40), 35+(M41), 35+(M42), 35+(M43), 35+(M44), 36+(A05), 36+(A07), 36+(A10), 36+(B02), 36+(B08), 36+(C22), 36+(C25), 36+(C38), 36+(C41), 36+(C49), 36+(C50), 36+(C51), 36+(D05), 36+(D06), 36+(G12), 36+(G13), 36+(H21), 36+(H30), 36+(H33), 36+(H37), 36+(H39), 36+(H50), 36+(H51), 36+(I01), 36+(I05), 36+(I08), 36+(L08), 36+(L10), 36+(L21), 36+(L35), 36+(M02), 36+(M08), 36+(M20), 36+(M21), 36+(M23), 36+(M32), 36+(M33), 36+(M34), 36+(M36), 36+(M37), 36+(M38), 36+(M40), 36+(M41), 36+(M42), 36+(M43), 36+(M44), 37+(A05), 37+(A07), 37+(A10), 37+(B02), 37+(B08), 37+(C22), 37+(C25), 37+(C38), 37+(C41), 37+(C49), 37+(C50), 37+(C51), 37+(D05), 37+(D06), 37+(G12), 37+(G13), 37+(H21), 37+(H30), 37+(H33), 37+(H37), 37+(H39), 37+(H50), 37+(H51), 37+(I01), 37+(I05), 37+(I08), 37+(L08), 37+(L10), 37+(L21), 37+(L35), 37+(M02), 37+(M08), 37+(M20), 37+(M21), 37+(M23), 37+(M32), 37+(M33), 37+(M34), 37+(M36), 37+(M37), 37+(M38), 37+(M40), 37+(M41), 37+(M42), 37+(M43), 37+(M44)

In the composition of the present invention and in the method of the present invention, a suitable mixing ratio of active ingredient A and active ingredient B, is such that, relative to 1 part by weight of active ingredient A, active ingredient B is usually from 0.001 to 1,000 parts by weight, preferably from 0.01 to 100 parts by weight, more preferably from 0.1 to 50 parts by weight, further more preferably from 0.1 to 10 parts by weight.

In the composition of the present invention and in the method of the present invention, a preferred amount of the active ingredient compound to be applied, may vary depending upon by e.g. the type of the target disease to be controlled, but is usually such that active ingredient A is from 0.1 to 1,000 g a.i./ha, preferably from 1 to 300 g a.i./ha, and active ingredient B is from 0.1 to 50,000 g a.i./ha, preferably from 0.1 to 1,000 g a.i./ha, more preferably from 1 to 300 g a.i./ha.

In the composition of the present invention and in the method of the present invention, a preferred amount of active ingredient B to be applied, may vary depending upon the type of active ingredient B, and as specific examples, it is from 1,000 to 50,000 ga.i/ha, preferably from 1,000 to 10,000 ga.i./ha, more preferably from 1,000 to 7,000 ga.i./ha in the case of copper oxychloride and fosetyl-aluminium, it is from 500 to 20,000 ga.i./ha, preferably from 500 to 7,000 ga.i./ha, more preferably from 500 to 4,000 ga.i./ha in the case of thiram, basic copper sulfate and propamocarb hydrochloride, it is from 300 to 10,000 ga.i/ha, preferably from 300 to 4,000 ga.i/ha, more preferably from 300 to 3,000 ga.i./ha in the case of triadimefon, dimethomorph and hymexazol, it is from 100 to 7,000 ga.i./ha, preferably from 100 to 2,000 ga.i./ha, more preferably from 100 to 1,000 ga.i/ha in the case of carbendazim, propiconazole, fenpyrazamine and cymoxanil, it is from 50 to 4,000 ga.i./ha, preferably from 50 to 1,000 ga.i./ha, more preferably from 50 to 500 ga.i./ha in the case of oxadixyl, zoxamide, enoxastrobin, fenaminstrobin, triclopyricarb, cyazofamid, validamycin, mandipropamid, imibenconazole, pyrisoxazole or triflumizole, it is from 1 to 2,000 ga.i./ha, preferably from 1 to 500 ga.i./ha, more preferably from 1 to 200 ga.i./ha in the case of metalaxyl-M and kasugamycin.

In this specification, a “plant disease control agent” means a fungicide or bactericide to control target harmful pathogenic bacteria that infects plants.

In this specification, “plant” means cereal, fruits or vegetables which are cultivated as human food, feed crops for e.g. livestock and poultry, ornamental plants to appreciate their appearance and shapes, or vascular plants (Tracheophyta) planted in parks or streets. Specifically, the following plants may, for example, be mentioned, but the plant is not limited thereto.

Pinales belonging to the pine family (Pinaceae), such as Japanese Red Pine (Pinus densiflora), Scots Pine (Pinus sylvestris), Japanese Black Pine (Pinus thunbergii), etc.

Magnolia (magnoliids) belonging to pepper family (Piperaceae) such as Pepper (Piper nigrum), Lauraceae such as Avocado (Persea americana), etc.,

Monocots belonging to Araceae such as Konjac (Amorphophallus konjac), Eddoe (Colocasia esculenta), etc., Dioscoreaceae such as Chinese yam (Dioscorea batatas), Japanese yam (Dioscorea japonica), etc., green onion family (Alliaceae) such as Leek (Allium ampeloprasum var. porrum), Onion (Allium cepa), Rakkyo (Allium chinense), Welsh onion (Allium fistulosum), Garlic (Allium sativum), Chives (Allium schoenoprasum), Chive (Allium schoenoprasum var. foliosum), Oriental garlic (Allium tuberosum), Scallion (Allium×wakegi), etc., Asparagaceae such as Asparagus (Asparagus officinalis), etc., palm family (Arecaceae) Dypsis lutescens subfamily (Arecoideae) such as Coconut palm (Cocos nucifera), Oil palm (Elaeis guineensis), etc., palm family (Arecaceae) talipot subfamily (Coryphoideae) such as Date palm (Phoenix dactylifera), etc., pineapple family (Bromeliaceae) such as Pineapple (Ananas comosus), etc., Gramineae (Poaceae) Eruharuta subfamily (Ehrhartoideae) such as Rice (Oryza sativa), etc., Gramineae (Poaceae) bluegrass subfamily (Pooideae) such as Bent grass (Agrostis spp.), Blue grass (Poa spp.), Barley (Hordeum vulgare), Wheat (Triticum aestivum, T. durum), Rye (Secale cereale), etc., Gramineae (Poaceae) Higeshiba subfamily (Chloridoideae) such as Bermuda grass (Cynodon dactylon), Grass (Zoysia spp.), etc., Gramineae (Poaceae) millet subfamily (Panicoideae) such as Sugarcane (Saccharum officinarum), Sorgum (Sorghum bicolor), Corn (Zea mays), etc., Musaceae such as Banana (Musa spp.), etc., ginger family (Zingiberaceae) such as Myoga (Zingiber mioga), Ginger (Zingiber officinale).

Eudicots belonging to lotus family (Nelumbonaceae) such as Lotus root (Nelumbo nucifera), etc., leguminous (Fabaceae) such as Peanut (Arachis hypogaea), Chickpea (Cicer arietinum), Lentil (Lens culinaris), Pea (Pisum sativum), Broad bean (Vicia faba), Soybean (Glycine max), Common bean (Phaseolus vulgaris), Adzuki bean (Vigna angularis), Cowpea (Vigna unguiculata), etc., hemp family (Cannabaceae) such as Hop (Humulus lupulus), etc., mulberry family (Moraceae) such as Fig Tree (Ficus carica). Mulberry (Morus spp.), etc., buckthorn family (Rhamnaceae) such as Common jujube (Ziziphus jujuba), etc., rose family (Rosaceae) rose subfamily (Rosoideae) such as Strawberry (Fragaria), Rose (Rosa spp.), etc., rose family (Rosaceae) pear subfamily (Maloideae) such as Japanese loquat (Eriobotrya japonica), Apple (Malus pumila), European Pear (Pyrus communis), Nashi Pear (Pyrus pyrifolia var. cufta), etc., rose family (Rosaceae) amygdaloideae (Prunoideae) such as Peach (Amygdalus persica), Apricot (Prunus armeniaca), Cherry (Prunus avium), Prune (Prunus domestica), Almond (Prunus dulcis), Japanese Apricot (Prunus mume), Japanese Plum (Prunus salicina), OOSHIMAZAKURA (Cerasus speciosa), Yoshino cherry tree (Cerasus×yedoensis ‘Somei-yoshino’), etc., Cucurbitaceae such as Winter melon (Benincasa hispida), Watermelon (Citrullus lanatus), Bottle gourd (Lagenaria siceraria var. hispida), Luffa (Luffa cylindrica), Pumpkin (Cucurbita spp.), Zucchini (Cucurbita pepo), Bitter melon (Momordica charantia var. pavel), Muskmelon (Cucumis melo), Oriental pickling melon (Cucumis melo var. conomon), Oriental melon (Cucumis melo var. makuwa), Cucumber (Cucumis sativus), etc., beech family (Fagaceae) such as Japanese Chestnut (Castanea crenata), etc., walnut family (Juglandaceae) such as Walnut (Juglans spp.), etc., Anacardiaceae such as Cashew (Anacardium occidentale), Mango (Mangifera indica), Pistachio (Pistacia vera), etc., mandarin orange family (Rutaceae) rue subfamily (Rutoideae) such as Japanese pepper (Zanthoxylum piperitum), etc., mandarin orange family (Rutaceae) mandarin orange subfamily (Aurantioideae) such as Bitter orange (Citrus aurantium), Lime (Citrus aurantifolia), Hassaku orange (Citrus hassaku), Yuzu (Citrus junos), Lemon (Citrus limon), Natsumikan (Citrus natsudaidai), Grapefruit (Citrus×paradisi), Orange (Citrus sinensis), Kabosu (Citrus sphaerocarpa), Sudachi (Citrus sudachi), Mandarin Orange (Citrus tangerina), Satsuma (Citrus unshiu), Kumquat (Fortunella spp.), etc., cruciferous (Brassicaceae) such as Horseradish (Armoracia rusticana), Mustard (Brassica juncea), Takana (Brassica juncea var. integrifolia), Rapeseed (Brassica napus), Cauliflower (Brassica oleracea var. botrytis), Cabbage (Brassica oleracea var. capitata), Brussels sprout (Brassica oleracea var. gemmifera), Broccoli (Brassica oleracea var. italica), Green pak choi (Brassica rapa var. chinensis), Nozawana (Brassica rapa var. hakabura), Napa cabbage (Brassica rapa var. nippo-oleifera), Potherb Mustard (Brassica rapa var. nipposinica), Napa cabbage (Brassica rapa var. pekinensis), Tumip leaf (Brassica rapa var. perviridis), Tumip (Brassica rapa var. rapa), Garden rocket (Eruca vesicaria), Daikon (Raphanus sativus var. longipinnatus), Wasabi (Wasabia japonica), etc., papaya family (Caricaceae) such as Papaya (Carica papaya), etc., Malvaceae such as Okra (Abelmoschus esculentus), Cotton plant (Gossypium spp.), Cacao (Theobroma cacao), etc., grape family (Vitaceae) such as Grape (Vitis spp.), etc., Amaranthaceae such as Sugar beet (Beta vulgaris ssp. vulgaris var. altissima), Table beet (Beta vulgaris ssp. vulgaris var. vulgaris), Spinach (Spinacia oleracea), etc., Polygonaceae such as Buckweat (Fagopyrum esculentum), etc., Ebenaceae such as Kaki Persimmon (Diospyros kaki), etc., camellia family (Theaceae) such as Tea plant (Camellia sinensis), etc., Actinidia family (Actinidiaceae) such as Kiwifruit (Actinidia deliciosa, A. chinensis), etc., azalea family (Ericaceae) such as Blueberry (Vaccinium spp.), Cranberry (Vaccinium spp.), etc., madder family (Rubiaceae) such as Coffee plants (Coffea spp.), etc., Lamiaceae such as Lemon balm (Melissa officinalis), Mint (Mentha spp.), Basil (Ocimum basilicum), Shiso (Perilla frutescens var. crispa), perilla (Perilla frutescens var. frutescens), Common Sage (Salvia officinalis), Thyme (Thymus spp.), etc., sesame family (Pedaliaceae) such as Sesame (Sesamum indicum), etc., Oleaceae such as Olive (Olea europaea), etc., Convolvulaceae family (Convolvulaceae) such as Sweet potato (Ipomoea batatas), etc., Solanaceae such as Tomato (Solanum lycopersicum), Eggplant (Solanum melongena), Potato (Solanum tuberosum), Chili pepper (Capsicum annuum), Bell pepper (Capsicum annuum var. ‘grossum’), Tobacco (Nicotiana tabacum), etc., Seri family (Apiaceae) such as Celery (Apium graveolens var. dulce), Coriander (Coriandrum sativum), Japanese honeywort (Cryptotaenia Canadensis subsp. japonica), Carrot (Daucus carota subsp. sativus), Parsley (Petroselium crispum), Italian parsley (Petroselinum neapolitanum), etc., Araliaceae such as Udo (Aralia cordata), Aralia elata, etc., Asteraceae thistle subfamily (Carduoideae) such as Artichoke (Cynara scolymus), etc., Asteraceae dandelion subfamily (Asteraceae) such as Chicory (Cichorium intybus), Lettuce (Lactuca sativa), etc., Asteraceae Chrysanthemum subfamily (Asteraceae) such as Florists' daisy (Dendranthema grandiflorum), Crown daisy (Glebionis coronaria), Sunflower (Helianthus annuus), Fuki (Petasites japonicus), Burdock (Arctium lappa), etc.

Further, the “plant” in this specification includes plants having resistince to HPPD inhibitors such as isoxaflutole, etc., ALS inhibitors such as imazethapyr, thifensulfuron-methyl, etc., EPSP synthetase inhibitors such as glyphosate, etc., glutamine synthetase inhibitors such as glufosinate, etc., acetyl-CoA carboxylase inhibitors such as sethoxydim, PPO inhibitors such as flumioxazin, etc., or herbicides such as bromoxynil, dicamba and 2,4-D, imparted by a classical breeding method or by a gene recombination technology.

As examples of “agricultural/horticultural plants” having such resistance imparted by a classical breeding method, there are rapeseed, wheat, sunflower, rice and corn which are resistant to imidazolinone type ALS inhibitory herbicides such as imazethapyr, etc., and they are already commercially available under the trade name “Clearfield”.

Similarly, there is soybean having resistance to sulfonylurea ALS inhibitory herbicides such as thifensulfuron-methyl, imparted by a classical breeding method, which is already commercially available under the trade name “STS soybean”. Similarly, SR corn, etc. are available as examples of agricultural/horticultural plants having resistance to acetyl CoA carboxylase inhibitors such as trione oxime type, aryloxy phenoxypropionic acid herbicides, imparted by a classical breeding method. Agricultural/horticultural plants having resistance to acetyl CoA carboxylase inhibitors imparted, are disclosed e.g. in Proceedings of the National Academy of Sciences of the United States of America (Proc. Nat. Acad. Sci. USA), Vol. 87, pp. 7175-7179 (1990). Further, mutant acetyl CoA carboxylase resistant to an acetyl CoA carboxylase inhibitor is reported in Weed Science, Vol. 53, pp. 728-746 (2005), etc., and by introducing such a mutant acetyl CoA carboxylase gene into a plant by a gene recombination technique, or by introducing a mutation to impart resistance into a crop acetyl CoA carboxylase, it is possible to produce a plant which is resistant to acetyl CoA carboxylase inhibitors. Further, as represented by the chimeric plasticine technology (Gura T. 1999. Repairing the Genome's Spelling Mistakes. Science 285: 316-318), base substitution mutation introducing nucleic acid is introduced into plant cells to induce a site-specific amino acid substitution mutation in the crop (acetyl-CoA carboxylase/herbicide target) gene, so that it is possible to produce a plant which is resistant to acetyl CoA carboxylase inhibitor/herbicide.

Examples of agricultural/horticultural plants having resistance imparted by gene recombination technology, include comrn, soybean, cotton, rapeseed and sugar beet varieties resistant to glyphosate, and they are already commercially available under trade names “Roundup Ready”, “AgrisureGT”, etc. Similarly, there are corn, soybean, cotton and rape varieties having glufosinate-resistance imparted by gene recombination technology, and they are already commercially available under a trade name “LibertyLink”, etc. Similarly, cotton having bromoxynil resistance imparted by genetic engineering technology is already commercially available under a trade name “BXN”.

The above “agricultural/horticultural plants” also include plants which became possible to synthesize selective toxins known e.g. in genus Bacillus, by using a genetic engineering technique.

Insecticidal toxins to be expressed in such genetically modified plants may, for example, be an insecticidal protein derived from Bacillus cereus or Bacillus popilliae; 6-endotoxin such as Cry1Ab, Cry1Ac, Cry1F, Cry1Fa2, Cry2Ab, Cry3A, Cry3Bb1 or Cry9C derived from Bacillus thuringiensis, or an insecticidal protein such as VIP1, VIP2, VIP3 or VIP3A; an insecticidal protein derived from nematode; a scorpion toxin, a spider toxin, a bee toxin or a toxin produced by an animal, such as an insect-specific neurotoxin; a yam fungal toxin; plant lectin; agglutinin; a trypsin inhibitor, a serine protease inhibitor, patatin, cystatin, a protease inhibitor such as a papain inhibitor, a ribosome inactivating protein (RIP) such as lysine, com-RIP, abrin, saporin, bryodin, etc.; a steroid metabolism enzyme such as 3-hydroxy steroid oxidase, ecdysteroid-UDP-glucosyltransferase, cholesterol oxidase, etc.; an ecdysone inhibitor, HMG-CoA reductase; an ion channel inhibitor such as a sodium channel inhibitor, a calcium channel inhibitor, etc.; juvenile hormone esterase; diuretic hormone receptor; stilbene synthase; bibenzyl synthase; chitinase; glucanase; etc.

Further, toxins to be expressed in such genetically modified plants also include hybrid toxins, partially deficient toxins and modified toxins of i-endotoxin protein, such as Cry1Ab, Cry1Ac, Cry1F, Cry1Fa2, Cry2Ab, Cry3A, Cry3Bb1 or Cry9C, or an insecticidal protein such as VIP1, VIP2, VIP3 or VIP3A. Hybrid toxins are produced by a new combination of different domains of such proteins by using recombinant techniques. As a partly deficient toxin, Cry1Ab with loss of a portion of the amino acid sequence is known. In a modified toxin, one or more amino acids of a naturally occurring toxin are substituted.

Examples of these toxins and recombinant plants capable of synthesizing these toxins are disclosed, for example, in patent documents such as EP-A-0374753, WO93/07278, WO95/34656, EP-A-0427529, EP-A-451878, WO03/052073. The toxins contained in such genetically modified plants will impart to the plants resistance, in particular, against Coleoptera pests, Diptera pests or lepidopteran pests.

Further, genetically modified plants that comprise one or more insecticidal pest-resistant genes, and express one or multiple toxins, are already known, and some of them are commercially available. Examples of such genetically engineered plants may, for example, be YieldGard <trade name> (a corn variety expressing Cry1Ab toxin), YieldGard Rootworm <trade name> (corn variety expressing Cry3Bb1 toxin), YieldGard Plus <trade name> (corn variety expressing Cry1Ab and Cry3Bb1 toxins), Herculex I <trade name> (corn variety expressing phosphinotricine N-acetyl transferase (PAT) for imparting resistance to CrylFa2 toxin and glufosinate), NuCOTN33B <trade name> (cotton variety expressing Cry1Ac toxin), Bollgard I<trade name> (cotton variety expressing Cry1Ac toxin), Boilgard II<trade name> (cotton variety expressing Cry1Ac and Cry2Ab toxins), VIPCOT <trade name> (cotton variety expressing VIP toxin), NewLeaf <trade name> (potato variety expressing Cry3A toxin), NatureGuard Agrisure GT Advantage (NatureGard <trade name> Agrisure <trade name> GT Advantage) (GA21 glyphosate-resistant trait), Agrisure CB Advantage (Agrisure <trade name> CB Advantage) (Bt11 corn borer (CB) trait), Protecta <trade name>, etc.

The aforementioned plants include those which have ability to generate antipathogenic substances having selective actions, imparted by using gene recombination techniques.

Such antipathogenic substances may, for example, be PR proteins (PRPs, described in EP-A-0392225); ion channel inhibitors such as sodium channel inhibitors, calcium channel inhibitors (viruses produced KPI, KP4, KP6 toxins, etc. have been known), etc.; stilbene synthase; bibenzyl synthase; chitinase; glucanase; substances, etc. produced by microorganisms, such as peptide antibiotics, antibiotics having a heterocyclic ring, protein factors relating to plant disease resistance [so-called plant disease resistance genes, as described in WO2003/000906]; etc. Such antipathogenic substances and genetically engineered plants to produce them, are disclosed in e.g. EP-A-0392225, WO95/33818, EP-A-0353191, etc.

The aforementioned plants also include plants having useful traits such as traits to improve oil stuff ingredients or to reinforce amino acid content, imparted by using gene recombination technology. As an example, VISTIVE <trade name> (low linolenic soybean having reduced linolenic content) or high-lysine (hig hoil) corn (corn having a lysine or oil content increased), may be mentioned.

Further, with respect to the above-described classic herbicide traits or herbicide tolerance genes, insecticidal pest-resistant genes, anti-pathogenic substance producing genes, and useful traits such as traits to improve oil stuff ingredients or to reinforce amino acid content, stack varieties having a plurality of them combined, are also included.

The “pathogen” in this specification means a microorganism which is a pathogen of plant disease, and specifically, the following microorganisms may, for example, be mentioned, but the pathogen is not limited thereto.

Ascomycota fungi, such as Taphrina spp. (for example, Taphrina deformans, T. pruni, etc.), Pneumocystis spp., Geotrichum spp., Candida spp. (for example, Candida albicans, C. sorbosa, etc.), Pichia spp. (for example, Pichia kluyveri, etc.), Capnodium spp., Fumago spp., Hypocapnodium spp., Cercospora spp. (for example, Cercospora apii, C. asparagi, C. beticola, C. capsici, C. carotae, C. kaki, C. kikuchii, C. zonata, etc.), Cercosporidium spp., Cladosporium spp. (for example, Cladosporium colocasiae, C. cucumerinum, C. variabile, etc.), Davidiella spp., Didymosporium spp., Heterosporium spp. (for example, Heterosporium allii, etc.), Mycosphaerella spp. (for example, Mycosphaerella arachidis, M. berkeleyi, M. cerasella, M. fijiensis, M. fragariae, M. graminicola, M. nawae, M. pinodes, M. pomi, M. zingiberis, etc.), Mycovellosiella spp. (for example, Mycovellosiella fulva, M. nattrassii, etc.), Paracercospora spp. (for example, Paracercospora egenula, etc.), Phaeoisariopsis spp., Phaeoramularia spp., Pseudocercospora spp. (for example, Pseudocercospora abelmoschi, P. fuligena, P. vitis, etc.), Pseudocercosporella spp. (for example, Pseudocercosporella capsellae, etc.), Ramichloridium spp., Ramularia spp., Septogloeum spp., Septoria spp. (for example, Septoria albopunctata, S. apiicola, S. chrysanthemella, S. helianthi, S. obesa, etc.), Sphaerulina spp., Aureobasidium spp., Kabatiella spp., Plowrightia spp., Stigmina spp., Elsinoe spp. (for example, Elsinoe ampelina, E. araliae, E. fawcettii, etc.), Sphaceloma spp. (for example, Sphaceloma caricae, etc.), Ascochyta spp. (for example, Ascochyta pisi, etc.), Corynespora spp. (for example, Corynespora cassiicola, etc.), Leptosphaeria spp. (for example, Leptosphaeria coniothyrium, L. maculans, etc.), Saccharicola spp., Phaeosphaeria spp. (for example, Phaeosphaeria nodorum, etc.), Ophiosphaerella spp., Setophoma spp., Helminthosporium spp., Altemaria spp. (for example, Altemaria altemata, A. brassicae, A. brassicicola, A. citri, A. dauci, A. helianthi, A. japonica, A. kikuchiana, A. mali, A. panax, A. porri, A. radicina, A. solani, etc.), Bipolaris spp. (for example, Bipolaris sorghicola, etc.), Cochliobolus spp. (for example, Cochliobolus heterostrophus, C. lunatus, C. miyabeanus, etc.), Curvularia spp. (for example, Curvularia geniculata, C. verruculosa, etc.), Drechslera spp., Pleospora spp. (for example, Pleospora herbarum, etc.), Pyrenophora spp. (for example, Pyrenophora graminea, P. teres, etc.), Setosphaeria spp. (for example, Setosphaeria turcica, etc.), Stemphylium spp. (for example, Stemphylium botryosum, S. lycopersici, S. solani, S. vesicarium, etc.), Fusicladium spp., Venturia spp. (for example, Venturia carpophila, V. Inaequalis, V. nashicola, V. pirina, etc.), Didymella spp. (for example, Didymella bryoniae, D. fabae, etc.), Hendersonia spp., Phoma spp. (for example, Phoma erratica var. mikan, P. exigua var. exigua, P. wasabiae, etc.), Pyrenochaeta spp. (for example, Pyrenochaeta lycopersici, etc.), Stagonospora spp. (for example, Stagonospora sacchari, etc.), Botryosphaeria spp. (for example, Botryosphaeria berengeriana f. sp. piricola, B. dothidea, etc.), Dothiorella spp., Fusicoccum spp., Guignardia spp., Lasiodiplodia spp. (for example, Lasiodiplodia theobromae, etc.), Macrophoma spp., Macrophomina spp., Neofusicoccum spp., Phyllosticta spp. (for example, Phyllosticta zingiberis, etc.), Schizothyrium spp. (for example, Schizothyrium pomi, etc.), Acrospermum spp., Leptosphaerulina spp., Aspergillus spp., Penicillium spp. (for example, Penicillium digitatum, P. italicum, P. sclerotigenum, etc.), Microsporum spp., Trichophyton spp. (for example, Trichophyton mentagrophytes, T. rubrum, etc.), Histoplasma spp., Blumeria spp. (for example, Blumeria graminis f. sp. hordei, B. g. f. sp. tritici, etc.), Erysiphe spp. (for example, Erysiphe betae, E. cichoracearum, E. c. var. cichoracearum, E. heraclei, E. pisi, etc.), Golovinomyces spp. (for example, Golovinomyces cichoracearum var. latisporus, etc.), Leveillula spp. (for example, Leveillula taurica, etc.), Microsphaera spp., Oidium spp. (for example, Oidium neolycopersici, etc.), Phyllactinia spp. (for example, Phyllactinia kakicola, P. mali, P. moricola, etc.), Podosphaera spp. (for example, Podosphaera fusca, P. leucotricha, P. pannosa, P. tridactyla var. tridactyla, P. xanthii, etc.), Sphaerotheca spp. (for example, Sphaerotheca aphanis var. aphanis, S. fuliginea, etc.), Uncinula spp. (for example, Uncinula necator, U. n. var. necator, etc.), Uncinuliella spp. (for example, Uncinuliella simulans var. simulans, U. s. var. tandae, etc.), Blumeriella spp. (for example, Blumeriella jaapii, etc.), Cylindrosporium spp., Diplocarpon spp. (for example, Diplocarpon mali, D. mespili, D. rosae, etc.), Gloeosporium spp. (for example, Gloeosporium minus, etc.), Marssonina spp., Tapesia spp. (for example, Tapesia acuformis, T. yallundae, etc.), Lachnum spp., Scleromitrula spp., Botryotinia spp. (for example, Botryotinia fuckeliana, etc.), Botrytis spp. (for example, Botrytis allii, B. byssoidea, B. cinerea, B. elliptica, B. fabae, B. squamosa, etc.), Ciborinia spp., Grovesinia spp., Monilia mumecola, Monilinia spp. (for example, Monilinia fructicola, M. fructigena, M. laxa, M. mali, M. vaccinii-corymbosi, etc.), Sclerotinia spp. (for example, Sclerotinia borealis, S. homoeocarpa, S. minor, S. sclerotiorum, etc.), Valdensia spp. (for example, Valdensia heterodoxa, etc.), Claviceps spp. (for example, Claviceps sorghi, C. sorghicola, etc.), Epichloe spp., Ephelis japonica, Villosiclava virens, Hypomyces spp. (for example, Hypomyces solani f. sp. mori, H. s. f. sp. pisi, etc.), Trichoderma spp. (for example Trichoderma viride, etc.), Calonectria spp. (for example, Calonectria ilicicola, etc.), Candelospora spp., Cylindrocarpon spp., Cylindrocladium spp., Fusarium spp. (for example, Fusarium arthrosporioides, F. crookwellense, F. culmorum, F. cuneirostrum, F. oxysporum, F. o. f. sp. adzukicola, F. o. f. sp. allii, F. o. f. sp. asparagi, F. o. f. sp. batatas, F. o. f. sp. cepae, F. o. f. sp. colocasiae, F. o. f. sp. conglutinans, F. o. f. sp. cubense, F. o. f. sp. cucumerinum, F. o. f. sp. fabae, F. o. f. sp. fragariae, F. o. f. sp. lactucae, F. o. f. sp. lagenariae, F. o. f. sp. lycopersici, F. o. f. sp. melongenae, F. o. f. sp. melonis, F. o. f. sp. nelumbinicola, F. o. f. sp. niveum, F. o. f. sp. radicis-lycopersici, F. o. f. sp. raphani, F. o. f. sp. spinaciae, F. sporotrichioides, F. solani, F. s. f. sp. cucurbitae, F. s. f. sp. eumartii, F. s. f. sp. glycines, F. s. f. sp. pisi, F. s. f. sp. Radicicola, F. virguliforme, etc.), Gibberella spp. (for example, Gibberella avenacea, G. baccata, G. fujikuroi, G. zeae, etc.), Haematonectria spp., Nectria spp., Ophionectria spp., Caldariomyces spp., Myrothecium spp., Trichothecium spp., Verticillium spp. (for example, Verticillium albo-atrum, V. dahliae, V. longisporum, etc.), Ceratocystis spp. (for example, Ceratocystis ficicola, C. fimbriata, etc.), Thielaviopsis spp. (for example, Thielaviopsis basicola, etc.), Adisciso spp., Monochaetia spp., Pestalotia spp. (for example, Pestalotia eriobotrifolia, etc.), Pestalotiopsis spp. (for example, Pestalotiopsis funerea, P. longiseta, P. neglecta, P. theae, etc.), Physalospora spp., Nemania spp., Nodulisporium spp., Rosellinia spp. (for example, Rosellinia necatrix, etc.), Monographella spp. (for example, Monographella nivalis, etc.), Ophiostoma spp., Cryphonectria spp. (for example, Cryphonectria parasitica, etc.), Diaporthe spp. (for example, Diaporthe citri, D. kyushuensis, D. nomurai, D. tanakae, etc.), Diaporthopsis spp., Phomopsis spp. (for example, Phomopsis asparagi, P. fukushii, P. obscurans, P. vexans, etc.), Cryptosporella spp., Discula spp. (for example, Discula theae-sinensis, etc.), Gnomonia spp., Coniella spp., Coryneum spp., Greeneria spp., Melanconis spp., Cytospora spp., Leucostoma spp., Valsa spp. (for example, Valsa ceratosperma, etc.), Tubakia spp., Monosporascus spp., Clasterosporium spp., Gaeumannomyces spp. (for example, Gaeumannomyces graminis, etc.), Magnaporthe spp. (for example, Magnaporthe grisea, etc.), Pyricularia spp. (for example, Pyricularia zingiberis, etc.), Monilochaetes infuscans, Colletotrichum spp. (for example, Colletotrichum acutatum, C. capsici, C. cereale, C. destructivum, C. fragariae, C. lindemuthianum, C. nigrum, C. orbiculare, C. spinaciae, etc.), Glomerella spp. (for example, Glomerella cingulata, etc.), Khuskia oryzae, Phyllachora spp. (for example, Phyllachora pomigena, etc.), Ellisembia spp., Briosia spp., Cephalosporium spp. (for example, Cephalosporium gramineum, etc.), Epicoccum spp., Gloeocercospora sorghi, Mycocentrospora spp., Peltaster spp. (for example, Peltaster fructicola, etc.), Phaeocytostroma spp., Phialophora spp. (for example, Phialophora gregata, etc.), Pseudophloeosporella dioscoreae, Pseudoseptoria spp., Rhynchosporium spp. (for example, Rhynchosporium secalis, etc.), Sarocladium spp., Coleophoma spp., Helicoceras oryzae, etc.

Basidiomycota fungi, such as Septobasidium spp. (for example, Septobasidium bogoriense, S. tanakae, etc.), Helicobasidium spp. (for example, Helicobasidium longisporum, etc.), Coleosporium spp. (for example, Coleosporium plectranthi, etc.), Cronartium spp., Phakopsora spp. (for example, Phakopsora artemisiae, P. nishidana, P. pachyrhizi, etc.), Physopella spp. (for example, Physopella ampelopsidis, etc.), Kuehneola spp. (for example, Kuehneola japonica, etc.), Phragmidium spp. (for example, Phragmidium fusiforme, P. mucronatum, P. rosae-multiflorae, etc.), Gymnosporangium spp. (for example, Gymnosporangium asiaticum, G. yamadae, etc.), Puccinia spp. (for example, Puccinia allii, P. brachypodii var. poae-nemoralis, P. coronata, P. c. var. coronata, P. cynodontis, P. graminis, P. g. subsp. graminicola, P. hordei, P. horiana, P. kuehnii, P. melanocephala, P. recondita, P. striiformis var. striiformis, P. tanaceti var. tanaceti, P. tokyensis, P. zoysiae, etc.), Uromyces spp. (for example, Uromyces phaseoli var. azukicola, U. p. var. phaseoli, Uromyces viciae-fabae var. viciae-fabae, etc.), Naohidemyces vaccinii, Nyssopsora spp., Leucotelium spp., Tranzschelia spp. (for example, Tranzschelia discolor, etc.), Aecidium spp., Blastospora spp. (for example, Blastospora smilacis, etc.), Uredo spp., Sphacelotheca spp., Urocystis spp., Sporisorium spp. (for example, Sporisorium scitamineum, etc.), Ustilago spp. (for example, Ustilago maydis, U. nuda, etc.), Entyloma spp., Exobasidium spp. (for example, Exobasidium reticulatum, E. vexans, etc.), Microstroma spp., Tilletia spp. (for example, Tilletia caries, T. controversa, T. laevis, etc.), Itersonilia spp. (for example, Itersonilia perplexans, etc.), Cryptococcus spp., Bovista spp. (for example, Bovista dermoxantha, etc.), Lycoperdon spp. (for example, Lycoperdon curtisii, L. perlatum, etc.), Conocybe spp. (for example, Conocybe apala, etc.), Marasmius spp. (for example, Marasmius oreades, etc.), Armillaria spp., Helotium spp., Lepista spp. (for example, Lepista subnuda, etc.), Scierotium spp. (for example, Scierotium cepivorum, etc.), Typhula spp. (for example, Typhula incamata, T. ishikariensis var. ishikariensis, etc.), Athelia spp. (for example, Athelia rolfsii, etc.), Ceratobasidium spp. (for example, Ceratobasidium comigerum, etc.), Ceratorhiza spp., Rhizoctonia spp. (for example, Rhizoctonia solani, etc.), Thanatephorus spp. (for example, Thanatephorus cucumeris, etc.), Laetisaria spp., Waitea spp., Fomitiporia spp., Ganoderma spp., Chondrostereum purpureum, Phanerochaete spp., etc.

Chitridiomycota fungi, such as Olpidium spp., etc.

Blastocladiomycota fungi, such as Physoderma spp., etc.

Mucoromycotina fungi, such as Choanephora spp., Choanephoroidea cucurbitae, Mucor spp. (for example, Mucor fragilis, etc.), Rhizopus spp. (for example, Rhizopus arrhizus, R. chinensis, R. oryzae, R. stolonifer var. stolonifer, etc.), etc.

Cercozoa protists, such as Plasmodiophora spp. (for example, Plasmodiophora brassicae, etc.), Spongospora subterranea f. sp. subterranea, etc.

Heterokontophyta Oomycetes, such as Aphanomyces spp. (for example, Aphanomyces cochlioides, A. raphani, etc.), Albugo spp. (for example, Albugo macrospora, A. wasabiae, etc.), Bremia spp. (for example, Bremia lactucae, etc.), Hyaloperonospora spp., Peronosclerospora spp., Peronospora spp. (for example, Peronospora alliariae-wasabi, P. chrysanthemi-coronani, P. destructor, P. farinosa f. sp. spinaciae, P. manshurica, P. parasitica, P. sparsa, etc.), Plasmopara spp. (for example, Plasmopara halstedii, P. nivea, P. viticola, etc.), Pseudoperonospora spp. (for example, Pseudoperonospora cubensis, etc.), Sclerophthora spp., Phytophthora spp. (for example, Phytophthora cactorum, P. capsici, P. citricola, P. citrophthora, P. cryptogea, P. fragariae, P. infestans, P. melonis, P. nicotianae, P. palmivora, P. porri, P. sojae, P. syringae, P. vignae f. sp. adzukicola, etc.), Pythium spp. (for example, Pythium afertile, P. aphanidermatum, P. apleroticum, P. aristosporum, P. arrhenomanes, P. buismaniae, P. debaryanum, P. graminicola, P. horinouchiense, P. irregulare, P. iwayamai, P. myriotylum, P. okanoganense, P. paddicum, P. paroecandrum, P. periplocum, P. spinosum, P. sulcatum, P. sylvaticum, P. ultimum var. ultimum, P. vanterpoolii, P. vexans, P. volutum, etc.), etc.

Actinobacteria gram-positive fungi, such as Clavibacter spp. (for example, Clavibacter michiganensis subsp. michiganensis, etc.), Curtobacterium spp., Leifsonia spp. (for example, Leifsonia xyli subsp. xyli, etc.), Streptomyces spp. (for example, Streptomyces ipomoeae, etc.), etc.

Firmicutes gram-positive fungi, such as Clostridium sp., etc.

Tenericutes gram-positive fungi, such as Phytoplasma, etc.

Proteobacteria gram-negative fungi, such as Rhizobium spp. (for example, Rhizobium radiobacter, etc.), Acetobacter spp., Burkholderia spp. (for example, Burkholderia andropogonis, B. cepacia, B. gladioli, B. glumae, B. plantarii, etc.), Acidovorax spp. (for example, Acidovorax avenae subsp. avenae, A. a. subsp. citrulli, A. konjaci, etc.), Herbaspirillum spp., Ralstonia spp. (for example, Ralstonia solanacearum, etc.), Xanthomonas spp. (for example, Xanthomonas albilineans, X. arboricola pv. pruni, X. axonopodis pv. vitians, X. campestris pv. campestris, X. c. pv. cucurbitae, X. c. pv. glycines, X. c. pv. mangiferaeindicae, X. c. pv. nigromaculans, X. c. pv. vesicatoria, X. citri subsp. citri, X. oryzae pv. oryzae, etc.), Pseudomonas spp. (for example, Pseudomonas cichorii, P. fluorescens, P. marginalis, P. m. pv. marginalis, P. savastanoi pv. glycinea, P. syringae, P. s. pv. actinidiae, P. s. pv. eriobotryae, P. s. pv. helianthi, P. s. pv. lachrymans, P. s. pv. maculicola, P. s. pv. mod, P. s. pv. morsprunorum, P. s. pv. spinaciae, P. s. pv. syringae, P. s. pv. theae, P. viridiflava, etc.), Rhizobacter spp., Brenneria spp. (for example, Brenneria nigrifluens, etc.), Dickeya spp. (for example, Dickeya dianthicola, D. zeae, etc.), Erwinia spp. (for example, Erwinia amylovora, E. rhapontici, etc.), Pantoea spp., Pectobacterium spp. (for example, Pectobacterium atrosepticum, P. carotovorum, P. wasabiae, etc.), etc.

As specific examples of plant diseases to be caused by infection and proliferation of these pathogens, the following plant diseases may, for example be mentioned, but the plant diseases are not limited thereto.

Leaf curl (Taphrina deformans), Plum pockets (Taphrina pruni), Leaf spot (Cercospora asparagi), Cercospora leaf spot (Cercospora beticola), Frogeye leaf spot (Cercospora capsici), Angular leaf spot (Cercospora kaki), Purple stain (Cercospora kikuchii), Brown Leaf spot (Mycosphaerella arachidis), Cylindrosporium leaf spot (Mycosphaerella cerasella, Blumeriella jaapii), Black sigatoka (Mycosphaerella fijiensis), Speckled leaf blotch (Mycosphaerella graminicola), Circular leaf spot (Mycosphaerella nawae), Mycosphaerella blight (Mycosphaerella pinodes), Leaf spot (Mycosphaerella zingiberis), Leaf mold (Mycovellosiella fulva), Leaf mold (Mycovellosiella nattrassii). Ceroospora leaf mold (Pseudocercospora fuligena), Isariopsis leaf spot (Pseudocercospora vitis), Leaf spot (Pseudocercosporella capsellae), Leaf spot (Septoria chrysanthemella), Leaf blight (Septoria obesa), Anthracnose (Elsinoe ampelina), Spot anthracnose (Elsinoe araliae), Scab (Elsinoe fawcettii), Leaf spot (Ascochyta pisi), Corynespora leaf spot (Corynespora cassiicola), Stem canker (Leptosphaeria coniothyrium), Glume blotch (Leptosphaeria nodorum), Leaf spot (Altemaria altemata), Altemaria leaf spot (Altemaria brassicae), Leaf blight (Altemaria dauci), Black spot (Altemaria kikuchiana), Altemaria blotch (Altemaria mali), Altemaria leaf spot (Altemaria porri), Target spot (Bipolaris sorghicola), Southern leaf blight (Cochliobolus heterostrophus), Brown spot (Cochliobolus miyabeanus). Tip blight (Pleospora herbarum), Stripe (Pyrenophora graminea), Net blotch (Pyrenophora teres), Leaf blight (Setosphaeria turcica), Northem leaf blight (Setosphaeria turcica), Leaf spot (Stemphylium botryosum), Scab (Venturia carpophila), Scab (Venturia Inaequalis), Scab (Venturia nashicola), Gummy stem blight (Didymella bryoniae), Leaf spot (Phoma exigua var. exigua), Streak (Phoma wasabiae), Ring rot (Botryosphaeria berengeriana f. sp. piricola), Soft rot (Botryosphaeria dothidea, Lasiodiplodia theobromae, Diaporthe sp.), Common green mold (Penicillium digitatum), Blue mold (Penicillium italicum), Powdery mildew (Blumeria graminis f. sp. hordei), Powdery mildew (Blumeria graminis f. sp. tritici), Powdery mildew (Erysiphe betae, Leveillula taurica, Oidium sp., Podosphaera xanthii), Powdery mildew (Erysiphe cichoracearum, Leveillula taurica, Sphaerotheca fuliginea), Powdery mildew (Erysiphe heradei), Powdery mildew (Erysiphe pisi), Powdery mildew (Leveillula taurica, Oidium neolycopersici, Oidium sp.), Powdery mildew (Leveillula taurica), Powdery mildew (Oidium sp., Podosphaera xanthii), Powdery mildew (Oidium sp.), Powdery mildew (Phyllactinia kakicola), Powdery mildew (Podosphaera fusca), Powdery mildew (Podosphaera leucotricha), Powdery mildew (Podosphaera pannosa, Uncinuliella simulans var. simulans, U. s. var. tandae), Powdery mildew (Podosphaera xanthii), Powdery mildew (Sphaerotheca aphanis var. aphanis), Powdery mildew (Sphaerotheca fuliginea), Powdery mildew (Uncinula necator, U. n. var. necator), Blotch (Diplocarpon mali), Black spot (Diplocarpon rosae), Gray mold neck rot (Botrytis allii), Gray mold, Botrytis blight (Botrytis cinerea), Grape gray mold (Botrytis cinerea), Leaf blight (Botrytis cinerea, B. byssoidea, B. squamosa), Chocolate spot (Botrytis cinerea, B. elliptica, B. fabae), Brown rot (Monilinia fructicola, M. fructigena, M. laxa), Blossom blight (Monilinia mali), Dollar spot (Scierotinia homoeocarpa), Cottony rot, Sclerotinia rot, Stem rot (Scierotinia scierotiorum), stem rot of rapeseed or cabbage (Sclerotinia sclerotiorum), False smut (Villosidava virens), Root necrosis (Calonectria ilicicola), Fusarium blight (Fusarium crookwellense, F. culmorum, Gibberella avenacea, G. zeae, Monographella nivalis), Fusarium blight (Fusarium culmorum, Gibberella avenacea, G. zeae), Dry rot (Fusarium oxysporum, F. solani f. sp. radicicola), Brown rot (Fusarium oxysporum, F. solani f. sp. pisi, F. s. f. sp. radicicola), Fusarium wilt (Fusarium oxysporum f. sp. adzukicola), Fusarium basal rot (Fusarium oxysporum f. sp. allii, F. solani f. sp. radicicola), Stem rot (Fusarium oxysporum f. sp. batatas, F. solani), Dry rot (Fusarium oxysporum f. sp. colocasiae), Yellows (Fusarium oxysporum f. sp. conglutinans), Panama disease (Fusarium oxysporum f. sp. cubense), Fusarium wilt (Fusarium oxysporum f. sp. fragariae), Root rot (Fusarium oxysporum f. sp. lactucae), Fusarium wilt (Fusarium oxysporum f. sp. lagenariae, F. o. f. sp. niveum), Fusarium wilt (Fusarium oxysporum f. sp. lycopersici), Fusarium wilt (Fusarium oxysporum f. sp. melonis), Yellows (Fusarium oxysporum f. sp. raphani), Fusarium wilt (Fusarium oxysporum f. sp. spinaciae), Soybean Sudden Death Syndrome (Fusarium solani f. sp. glycines, Fusarium virguliforme), “Bakanae” disease (Gibberella fujikuroi), Verticillium black spot (Verticillium albo-atrum, V. dahliae), Verticillium wilt (Verticillium dahliae), Ceratocystis canker (Ceratocystis ficicola), Black rot (Ceratocystis fimbriata), Gray blight (Pestalotiopsis longiseta, P. theae), Endothia canker (Cryphonectria parasitica), Melanose (Diaporthe citri), Stem blight (Phomopsis asparagi). Phomopsis canker (Phomopsis fukushii), Brown spot (Phomopsis vexans), Anthracnose (Discula theae-sinensis), Valsa canker (Valsa ceratosperma), Blast (Magnaporthe grisea), Crown rot (Colletotrichum acutatum, C. fragariae, Glomerella cingulata), Bitter rot (Colletotrichum acutatum, Glomerella cingulata), Anthracnose (Colletotrichum acutatum, Glomerella cingulata), Anthracnose (Colletotrichum acutatum), Ripe rot (Colletotrichum acutatum, Glomerella cingulata), Anthracnose (Colletotrichum acutatum), Anthracnose (Colletotrichum lindemuthianum), Anthracnose (Colletotrichum orbiculare), Anthracnose (Glomerella cingulata), Anthracnose (Glomerella cingulata), Anthracnose (Glomerella cingulata), Brown stem rot (Phialophora gregata), Leaf spot (Pseudophloeosporella dioscoreae), Scald (Rhynchosporium secalis),

Rust (Phakopsora nishidana), Rust (Phakopsora pachyrhizi), Rust (Kuehneola japonica, Phragmidium fusiforme, P. mucronatum, P. rosae-multiflorae), Rust (Gymnosporangium asiaticum), Rust (Gymnosporangium yamadae), Rust (Puccinia allii), Rust (Puccinia horiana), Brown rust (Puccinia recondite), Rust (Puccinia tanaceti var. tanaceti), Rust (Uromyces viciae-fabae var. viciae-fabae), Smut (Sporisorium scitamineum), Smut (Ustilago maydis), Loose smut (Ustilago nuda), Net blister blight (Exobasidium reticulatum), Blister blight (Exobasidium vexans), Stem rot, Southern blight (Athelia rolfsii), Root and stem rot (Ceratobasidium comigerum, Rhizoctonia solani), ginger crest blight (Rhizoctonia solani), Damping-off (Rhizoctonia solani), Damping-off (Rhizoctonia solani), Bottom rot (Rhizoctonia solani), Brown patch, Large patch (Rhizoctonia solani), Sheath blight (Thanatephorus cucumeris), Root rot Leaf blight (Thanatephorus cucumeris),

Rhizopus rot (Rhizopus stolonifer var. stolonifer),

Clubroot (Plasmodiophora brassicae),

Aphanomyces root rot (Aphanomyces cochlioides), White rust (Albugo macrospora), Downy mildew (Bremia lactucae), Downy mildew (Peronospora chrysanthemi-coronarii), Downy mildew (Peronospora destructor), Downy mildew (Peronospora farinosa f. sp. spinaciae), Downy mildew (Peronospora manshurica), Downy mildew (Peronospora parasitica), Downy mildew (Peronospora sparsa), Downy mildew (Plasmopara halstedii), Downy mildew (Plasmopara nivea), Downy mildew (Plasmopara viticola), Downy mildew (Pseudoperonospora cubensis), Phytophthora root rot (Phytophthora cactorum), Brown rot (Phytophthora capsici), Phytophthora rot (Phytophthora capsici), Phytophthora blight (Phytophthora capsici), Phytophthora rot (Phytophthora cryptogea), Late blight (Phytophthora infestans), White powdery rot (Phytophthora palmivora), Leaf blight (Phytophthora porri), Phytophthora root and stem rot (Phytophthora sojae), Phytophthora stem rot (Phytophthora vignae f. sp. adzukicola), Damping-off (Pythium aphanidermatum, P. myriotylum, P. paroecandrum, P. ultimum var. ultimum), Root rot (Pythium aristosporum), Browning root rot (Pythium arrhenomanes, P. graminicola), Damping-off (Pythium buismaniae, P. myriotylum), Root rot (Pythium myriotylum), Root rot (Pythium myriotylum, P. ultimum var. ultimum), Brown blotted root rot (Pythium sulcatum),

Bacterial canker (Clavibacter michiganensis subsp. michiganensis), Scab (Streptomyces spp.),

Crown gall (Rhizobium radiobacter), Bacterial stripe (Burkholderia andropogonis), Soft rot (Burkholderia cepacia, Pseudomonas marginalis pv. marginalis, Erwinia rhapontici), Bacterial grain rot (Burkholderia gladioli, B. glumae), Bacterial fruit blotch (Acidovorax avenae subsp. citrulli), Bacterial leaf blight (Acidovorax konjaci), Bacterial wilt (Ralstonia solanacearum), Bacterial shot hole (Xanthomonas arboricola pv. pruni, Pseudomonas syringae pv. syringae, Brenneria nigrifluens), Bacterial leaf spot (Xanthomonas arboricola pv. pruni), Bacterial spot (Xanthomonas axonopodis pv. vitians), Black rot (Xanthomonas campestris pv. campestris), Bacterial pustule (Xanthomonas campestris pv. glycines), Bacterial spot (Xanthomonas campestris pv. nigromaculans), Bacterial spot (Xanthomonas campestris pv. vesicatoria), Citrus canker (Xanthomonas citri subsp. citri), garlic spring rot (Pseudomonas cichorii, P. marginalis pv. marginalis, Erwinia sp.), Bacterial rot (Pseudomonas cichorii, P. marginalis pv. marginalis, P. viridiflava), Bacterial blossom blight (Pseudomonas marginalis pv. marginalis, P. syringae pv. syringae, P. viridiflava), Bacterial canker (Pseudomonas syringae pv. actinidiae), Canker (Pseudomonas syringae pv. eriobotryae), Bacterial spot (Pseudomonas syringae pv. lachrymans), Bacterial black spot (Pseudomonas syringae pv. maculicola), Bacterial canker (Pseudomonas syringae pv. morsprunorum, Erwinia sp.), Bacterial shoot blight (Pseudomonas syringae pv. theae). Bacterial soft rot (Dickeya sp., Pectobacterium carotovorum), Fire blight (Erwinia amylovora), Soft rot (Pectobacterium carotovorum), Bacterial soft rot (Pectobacterium carotovorum).

The “useful insects” in this specification means insects useful in that products which they produce, may be utilized for human life, or they may contribute to efficiency of agricultural operations as they may be used for pollination of fruits or vegetables. Specifically, for example, Japanese honeybee (Apis cerana japonica), Western honey bee (Apis mellifera), Bumblebee (Bombus consobrinus wittenburgi, B. diversus diversus, B. hypocrita hypocrita, B. ignitus, B. terrestris), Homfaced bee (Osmia comifrons) and Silkworm (Bombyx mori), may be mentioned, but the useful insects are not limited to these.

The “natural enemies” in this specification means organisms which, by predation and parasitism, will kill or inhibit growth of a specific species of organism, especially a specific species of organism that harm crops. Specifically, the following organisms may, for example, be mentioned, but specific examples of natural enemies are not limited thereto.

Parasitic wasps belonging to Braconidae such as Dacnusa sasakawai, Dacnusa sibirica, Aphidius colemani, Apanteles glomeratus, etc., Aphelinidae such as Aphelinus albipodus, Aphelinus asychis, Aphelinus gossypii, Aphelinus maculatus, Aphelinus varipes, Encarsia formosa, Eretmocerus eremicus, Eretmocerus mundus, etc., and Eulophidae such as Chrysocharis pentheus, Neochrysocharis formosa, Diglyphus isaea, Hemiptarsenus varicomis, etc.; Aphidophagous gall midge (Aphidoletes aphidimyza); Seven-spot ladybird (Coccinella septempunctata); Asian lady beetle (Harmonia axyridis); Predatory beetle (Propylea japonica); Anthocorid predatory bugs belonging to Anthocoridae such as Orius minutus, Orius nagaii, Orius sauten, Minute pirate bug (Orius strigicollis); Predatory mirid belonging to Miridae such as Pilophorus typicus, Nesidiocoris tenuis, etc.; Predatory thrips belonging to Aeolothripidae such as Franklinothrips vespiformis; Green lacewing belonging to Chrysopidae such as Dichochrysa formosanus, Chrysoperla nipponensis, etc.; Predatory mite belonging to Phytoseiidae such as Neoseiulus califomicus, Amblyseius cucumeris, Amblyseius degenerans, Amblyseius swirskii, Phytoseiulus persimilis, etc.; Wolf spider (Pardosa pseudoannulata); Crab spider (Misumenops tricuspidatus).

The composition of the present invention can effectively control many plant diseases that occur in vascular plants (Tracheophyta) such as Pinales, magnoliids, monocots, eudicots, etc.

Pathogens may, for example, be Ascomycota fungi, Basidiomycota fungi, Chitridiomycota fungi, Blastocladiomycota fungi, Mucoromycotina fungi, Cercozoa protists, Heterokontophyta Oomycetes, Actinobacteria Gram-positive fungi, Tenericutes Gram-positive fungi and Proteobacteria Gram-negative fungi, etc.

The composition of the present invention exhibits excellent control effects at a low concentration, especially against plant pathogenic fungi belonging to Ascomycota and Basidiomycota, among such pathogens.

The composition of the present invention may be used in the form of a mixture obtained simply by mixing active ingredient A selected from oxime-substituted amide compounds of the formula (I) and active ingredient B selected from known fungicidal or bactericidal active compounds, but may usually be practically used as formulated into an optional formulation such as a soluble concentrate, an emulsifiable concentrate, a wettable powder, a water soluble powder, a water dispersible granule, a water soluble granule, a suspension concentrate, a concentrated emulsion, a suspoemulsion, a microemulsion, a dustable powder, a granule, a tablet or an emulsifiable gel, by mixing with a suitable solid carrier or liquid carrier, and further optionally by adding surfactants, penetrating agents, spreading agents, thickeners, antifreeze agents, binders, anti-caking agents, disintegrants, defoamers, preservatives, stabilizing agents, etc. From the viewpoint of laborsaving and safety improvement, the above optional formulation may be supplied as sealed in a water soluble capsule or a water-soluble package such as a bag made of a water-soluble film.

Solid carriers may, for example, be natural minerals, such as quartz, calcite, meerschaum, dolomite, chalk, kaolinite, pyrophyllite, sericite, halloysite, metahalloysite, kibushi clay, frog eyes clay, pottery stone, zeeklite, allophane, whitebait, Kira, talc, bentonite, activated clay, acid clay, pumice, attapulgite, zeolite, diatomaceous earth, etc.; baked products of natural minerals, such as calcined day, perlite, Shirasu balloon, vermiculite, Ata Pal gas clay, calcined diatomaceous earth, etc.; inorganic salts, such as magnesium carbonate, calcium carbonate, sodium carbonate, sodium hydrogen carbonate, ammonium sulfate, sodium sulfate, magnesium sulfate, diammonium hydrogen phosphate, ammonium dihydrogen phosphate, potassium chloride, etc.; sugars such as glucose, fructose, sucrose, lactose, etc.; polysaccharides, such as starch, powdered cellulose, dextrin, etc.; organic materials, such as urea, urea derivatives, benzoic acid, a salt of benzoic acid, etc.; plants, such as wood flour, cork powder, corn cobs, walnut shell, tobacco stems, etc.; fly ash, white carbon (for example, hydrous synthetic silica, anhydrous synthetic silica, hydrous synthetic silicate, etc.), a fertilizer; etc.

The liquid carriers may, for example, be aromatic hydrocarbons, such as xylene, alkyl (e.g. C₉ or C₁₀) benzene, phenylxylylethane and alkyl (e.g. C₁ or C₃) naphthalene, etc.; aliphatic hydrocarbons, such as machine oil, normal paraffin, isoparaffin, naphthene, etc.; mixtures of aromatic hydrocarbons and aliphatic hydrocarbons, such as kerosene, etc.; alcohols, such as ethanol, isopropanol, cyclohexanol, phenoxyethanol, benzyl alcohol, etc.; polyhydric alcohols, such as ethylene glycol, propylene glycol, diethylene glycol, hexylene glycol, polyethylene glycol, polypropylene glycol, etc.; ethers, such as propyl cellosolve, butyl cellosolve, phenyl cellosolve, propylene glycol monomethyl ether, propylene glycol monoethyl ether, propylene glycol monopropyl ether, propylene glycol monobutyl ether, propylene glycol monophenyl ether, etc.; ketones, such as acetophenone, cyclohexanone, γ-butyrolactone, etc.; esters, such as fatty acid methyl esters, succinic acid dialkyl esters, glutamic acid dialkyl esters, adipic acid dialkyl esters, phthalic acid dialkyl esters, etc.; acid amides, such as N-alkyl (C₁, C₈, C₁₂, etc.) pyrrolidone, etc.; oils, such as soybean oil, linseed oil, rapeseed oil, coconut oil, cottonseed oil, castor oil, etc.; dimethylsulfoxide, water; etc.

These solid and liquid carriers may be used alone or in combination of two or more of them.

The surfactants may, for example, be nonionic surfactants such as polyoxyethylene alkyl ethers, polyoxyethylene alkyl (mono- or di-)phenyl ethers, polyoxyethylene (mono-, di- or tri-)styrylphenyl ethers, polyoxyethylene polyoxypropylene block copolymers, acrylic grafted copolymer, polyoxyethylene fatty acid (mono- or di-)esters, sorbitan fatty acid esters, polyoxyethylene sorbitan fatty acid (mono-, di-, tri- or tetra-) esters, polyoxyethylene sorbitol fatty acid (mono-, di-, tri-, tetra-, penta- or hexa-) esters, polyoxyethylene polyol fatty acid ester, castor oil ethylene oxide adducts, acetylene glycol, acetylene alcohol, ethylene oxide adducts of acetylene glycol, ethylene oxide adducts of acetylene alcohol, alkyl glycosides, etc.; anionic surfactants, such as alkyl sulfates, alkylbenzene sulfonates, lignin sulfonates, alkyl sulfosuccinates, naphthalene sulfonates, alkylnaphthalene sulfonates, salts of formalin condensate of naphthalenesulfonic acid, salts of formalin condensate of alkylnaphthalene sulfonic acid, polyoxyethylene alkyl ether sulfuric acid or phosphoric acid ester salts, polyoxyethylene (mono- or di-)alkylphenyl ether sulfate or phosphate ester salts, polyoxyethylene (mono-, di- or tri)styrylphenyl ether sulfuric or phosphoric ester salts, polycarboxylates (for example, polyacrylic acid salts, polymaleic acid salts, a copolymer of maleic acid and olefin, etc.), polystyrene sulfonate, etc.; cationic surfactants, such as alkyl amine salts, alkyl quaternary ammonium salts, etc.; amphoteric surfactants of amino acid type, betaine type, etc.; silicone surfactants, fluorine surfactants; etc.

The content of such surfactant(s) is not particularly limited, but is usually in the range of preferably from 0.05 to 20 parts by weight, more preferably from 0.1 to 15 parts by weight, relative to 100 parts by weight of the formulation of the composition of the present invention. These surfactants may be used alone or in combination of two or more of them.

The application amount of the composition of the present invention may vary depending upon the application scene, application time, application method, cultivated plants, etc., but usually, as the amount of active ingredient, is suitably from 0.005 to 50 kg, preferably from 0.01 to 20 kg, more preferably from 0.01 to 5 kg, furthermore preferably from 0.01 to 2 kg, per hectare (ha).

Now, examples of formulations in the case of using the composition of the present invention, will be presented. However, formulations of the present invention are not limited thereto.

In the following Formulation Examples, “parts” means parts by weight, and “active ingredient compound” is a general term for active ingredient A, and for active ingredient B.

[Wettable Powder]

| | | |
|---|---|---|
| Active ingredient compound | 0.1 to 80 | parts |
| Solid carrier | 5 to 98.9 | parts |
| Surfactant | 1 to 10 | parts |
| Others | 0 to 5 | parts |

Others may, for example, be an anti-caking agent, a stabilizing agent, etc.

[Emulsion]

| | | |
|---|---|---|
| Active ingredient compound | 0.1 to 30 | parts |
| Organic solvent | 45 to 95 | parts |
| Surfactant | 4.9 to 30 | parts |
| Water | 0 to 50 | parts |
| Others | 0 to 10 | parts |

Others may, for example, be a spreading agent, a stabilizing agent, etc.

[Suspension]

| | | |
|---|---|---|
| Active ingredient compound | 0.1 to 70 | parts |
| Liquid carrier | 15 to 98.89 | parts |
| Surfactant | 1 to 12 | parts |
| Others | 0.01 to 30 | parts |

Others may, for example, be an anti-freezing agent, a thickener, etc.

[Water Dispersible Granules]

| | |
|---|---|
| Active ingredient compound | 0.1 to 90 parts |
| Solid carrier | 0 to 98.9 parts |
| Surfactant | 1 to 20 parts |
| Others | 0 to 10 parts |

Others may, for example, be a binder, a stabilizing agent, etc.

[Solution]

| | |
|---|---|
| Active ingredient compound | 0.01 to 70 parts |
| Liquid carrier | 20 to 99.99 parts |
| Others | 0 to 10 parts |

Others may, for example, be an anti-freezing agent, a spreading agent, etc.

[Granules]

| | |
|---|---|
| Active ingredient compound | 0.01 to 80 parts |
| Solid carrier | 10 to 99.99 parts |
| Others | 0 to 10 parts |

Others may, for example, be a binding agent, a stabilizing agent, etc.

[Powder]

| | |
|---|---|
| Active ingredient compound | 0.01 to 30 parts |
| Solid carrier | 65 to 99.99 parts |
| Others | 0 to 5 parts |

Others may, for example, be a drift preventing agent, a stabilizing agent, etc.

Now, Formulation Examples wherein the composition of the present invention using active ingredients, is more specifically shown, will be presented, but the present invention is not limited thereto.

### [Formulation Example 1] Wettable Powder

| | |
|---|---|
| Compound No. 20 | 10 parts |
| Compound No. C49 | 10 parts |
| Pyrophyllite | 74 parts |
| Sorpol 5039 | 4 parts |
| (trade name, mixture of nonionic surfactant and anionic | |
| surfactant: manufactured by Toho Chemical Industry Co., Ltd.) | |
| CARPLEX #80D | 2 parts |
| (trade name, synthetic hydrous silicic acid: manufactured by | |
| Shionogi & Co., Ltd. The same applies hereinafter.) | |

The above components are uniformly mixed and pulverized to obtain a wettable powder.

### [Formulation Example 2] Emulsifiable Concentrate

| | |
|---|---|
| Compound No. 18 | 3 parts |
| Compound No. C50 | 2 parts |
| Xylene | 75 parts |
| N-Mechiripiroridon | 15 parts |
| Sorpol 2680 | 15 parts |
| (trade name, mixture of nonionic surfactant and anionic | |
| surfactant: manufactured by Toho Chemical Industry Co., Ltd.) | |

The above components are uniformly mixed to obtain an emulsifiable concentrate.

### [Formulation Example 3] Emulsifiable Concentrate

| | |
|---|---|
| Compound No. 24 | 2 parts |
| Compound No. H50 | 2 parts |
| DBE | 36 parts |
| (trade name, a mixture of dimethyl adipate, dimethyl glutarate | |
| and dimethyl succinate; manufactured by INVISTA Co., Ltd. | |
| The same applies hereinafter.) | |
| Isobutyl adipate | 30 parts |
| N-methylpyrrolidone | 10 parts |
| Soprophor BSU | 14 parts |
| (trade name, nonionic surfactant; manufactured by Rhodia | |
| (Rhodia) Co., Ltd. The same applies hereinafter.) | |
| Rhodacal 70BC | 6 parts |
| (trade name, anionic surfactant: manufactured by Rhodia Co., | |
| Ltd. The same applies hereinafter.) | |

The above components are uniformly mixed to obtain an emulsifiable concentrate.

### [Formulation Example 4] Emulsifiable Concentrate

| | |
|---|---|
| Compound No. 27 | 2 parts |
| Compound No. H50 | 2 parts |
| DBE | 11 parts |
| Isobutyl adipate | 30 parts |
| N-methylpyrrolidone | 5 parts |
| Soprophor BSU | 14 parts |
| Rhodacal 70BC | 6 parts |
| Propylene glycol | 10 parts |
| Water | 20 parts |

The above components are uniformly mixed to obtain an emulsifiable concentrate.

### [Formulation Example 5] Suspension Concentrate

| | |
|---|---|
| Compound No. 25 | 15 parts |
| Compound No. C49 | 10 parts |
| Agrisol S-710 | 10 parts |
| (trade name, nonionic surfactant; manufactured by Kao | |
| Corporation) | |
| Lennox 1000C | 0.5 parts |
| (trade name, anionic surfactant: manufactured by Toho | |
| Chemical Industry Co., Ltd.) | |
| Xanthan gum | 0.2 parts |
| Water | 64.3 parts |

The above components are uniformly mixed, followed by wet pulverization to obtain a suspension concentrate.

### [Formulation Example 6] Water Dispersible Granule

| | |
|---|---|
| Compound No. 28 | 40 parts |
| Compound No. C50 | 35 parts |
| High tenor NE-15 | 5 parts |
| (trade name, anionic surfactant; manufactured by Dai-ichi Kogyo | |
| Seiyaku Co., Ltd.) | |
| VANILLEX N | 10 parts |
| (trade name, anionic surfactant; manufactured by Nippon Paper | |
| Industries Co., Ltd.) | |
| CARPLEX #80D | 10 parts |

The above components are uniformly mixed and pulverized, then after addition of a small amount of water, stirred and mixed, and granulated by an extrusion granulator, followed by drying to obtain a water dispersible granule.

### [Formulation Example 7] Granule

| | |
|---|---|
| Compound No. 34 | 3 parts |
| Compound No. C50 | 2 parts |
| Bentonite | 50 parts |
| Talc | 45 parts |

The above components are uniformly mixed and pulverized, then after adding a small amount of water, stirred and mixed, and granulated by an extrusion granulator, followed by drying to obtain granules.

### [Formulation Example 8] Dustable Powder

| | |
|---|---|
| Compound No. 35 | 2 parts |
| Compound No. C49 | 1 part |
| CARPLEX #80D | 0.5 part |
| Kaolinite | 95 parts |
| Diisopropyl phosphate | 1.5 parts |

The above components are uniformly mixed and pulverized to obtain a dustable powder.

In use of the composition of the present invention, the above respective formulations will be diluted from 1 to 20,000 times with water, and will be applied so that the active ingredient would be from 0.005 to 50 kg, preferably from 0.01 to 20 kg, more preferably from 0.01 to 5 kg, furthermore preferably from 0.01 to 2 kg, per hectare (ha).

In the present invention, a composition comprising the above active ingredient A and active ingredients B may be formulated as mentioned above, and used. Further, an agent containing active ingredient A and an agent containing active ingredient B may be separately prepared, and these separate agents may be used for treatment or application at the same time or in close temporal proximity, so as to obtain synergistic excellent controlling effects. Here, when they are to be applied in the above temporal proximity, these separate agents may be continuously applied, but it is desirable to perform the subsequent application after the agent initially applied is sufficiently dried, although such may depend also on the controlling means, the target disease to be controlled, etc.

Here, in the case of using the separate agents which contain active ingredient A and active ingredient B, respectively, as active ingredients, the ratio of both active ingredients used is the same including the preferred embodiments, as the content ratio of active ingredient A and active ingredient B in the composition comprising both active ingredients A and active ingredient B. Further, from the viewpoint of efficiency of the work, etc., it is preferred to use the composition comprising both active ingredient A and active ingredient B, as active ingredients.

### EXAMPLES

Now, in order to specifically demonstrate the usefulness of the present invention, Test Examples will be given below, but the present invention is by no means limited by these Examples.

### [Test Example 1] Preventive Test Against Gray Mold

Using the following compound listed in the above Table 2 (the active ingredient A) and the compound listed in the above Table 4 through Table 18 (active ingredient B), an agent was prepared in accordance with the above Formulation Example of emulsifiable concentrate. Such an agent was diluted with water to a predetermined concentration to obtain a test solution. Then, cucumber (variety: Sagami-hanjiro) was planted in a plastic pot of 90 cm³, and in the cotyledon stage, 5 ml of the obtained test solution, was sprayed by a spray gun and air-dried. Thereafter, the treated leaf was cut off and placed in a plastic container which filled approximately 0.5 cm in depth water. A suspension of conidia of cucumber gray mold fungus (Botrytis cinerea) and a dissolved PDA culture medium were mixed at a ratio of 1:1 (mass ratio), and the mixture was dropped to inoculate the treated leaf with 30 μl. After the inoculation, the plastic container was sealed and left at 20° C. for 3 days, the ratio of the formed lesion occupying the inoculated leaf was measured, and the preventive value (observed value) was calculated in accordance with the following calculation formula. The results are shown in Table 19 through Table 21.

Preventive value=[1−(treated plot lesion area ratio/untreated plot lesion area ratio)]×100

Further, from the preventive value at each agent concentration, a theoretical value expected by treatment of the mixing (theoretical value) was calculated by using the Colby method (Colby S. R. 1967, Weeds 15, 20-22), in order to analyze synergy. The calculation method is as follows.

E=X+Y−XY/100

X: preventive value of A agent (test solution obtained from active ingredient A) at x concentration

Y: preventive value of B agent (test solution obtained from active ingredient B) at y concentration

E: theoretical value expected by treatment of the mixture of A agent and B agent.

In the observed value and the theoretical value, calculated as the above, the obtained result is analyzed to be synergy if the observed value is larger than the theoretical value, to be antagonism if the theoretical value is larger than the observed value, and to be an additive effect if the observed value and the theoretical value are the same.

TABLE 19

| Compound No. | Concentration (ppm) | Preventive value |
|---|---|---|
| 18 | 0.5 | 59 |
| 20 | 0.5 | 10 |
| 25 | 0.5 | 63 |
| 27 | 0.5 | 21 |
| 28 | 0.5 | 38 |
| 34 | 0.5 | 65 |
| 35 | 0.5 | 45 |
| 36 | 0.5 | 49 |

TABLE 20

| Compound No. | Concentration (ppm) | Preventive value |
|---|---|---|
| H50 | 5 | 56 |
| C49 | 1 | 45 |
| C50 | 1 | 70 |
| A05 | 100 | 5 |
| A07 | 100 | 10 |
| A10 | 100 | 10 |
| B02 | 10 | 85 |
| B08 | 100 | 15 |
| C22 | 100 | 85 |
| C25 | 10 | 55 |
| C38 | 100 | 69 |
| C41 | 100 | 10 |
| C51 | 100 | 48 |
| D05 | 100 | 28 |
| D06 | 100 | 13 |
| G12 | 100 | 15 |
| G13 | 100 | 28 |
| H21 | 10 | 20 |
| H30 | 100 | 38 |
| H33 | 100 | 9 |
| H37 | 100 | 38 |
| H39 | 100 | 10 |
| H51 | 10 | 53 |
| I01 | 100 | 10 |
| I05 | 100 | 18 |
| I08 | 100 | 10 |
| L08 | 100 | 5 |
| L10 | 100 | 18 |
| L21 | 100 | 28 |
| L35 | 100 | 23 |
| M02 | 100 | 13 |
| M08 | 100 | 10 |
| M20 | 10 | 60 |
| M21 | 1 | 65 |
| M23 | 100 | 54 |
| M34 | 100 | 10 |
| M44 | 10 | 28 |

TABLE 21

| Compound No. | | |
|---|---|---|
| [Concentration (ppm)] | Preventive value | Theoretical Value |
| 18(0.5) + H50(5) | 100 | 82 |
| 18(0.5) + C49(1) | 94 | 77 |
| 18(0.5) + C50(1) | 89 | 77 |
| 20(0.5) + H50(5) | 75 | 60 |
| 20(0.5) + C49(1) | 72 | 51 |
| 20(0.5) + C50(1) | 83 | 73 |
| 25(0.5) + H50(5) | 100 | 84 |
| 25(0.5) + C49(1) | 97 | 80 |
| 25(0.5) + C50(1) | 100 | 89 |
| 27(0.5) + H50(5) | 79 | 65 |
| 27(0.5) + C49(1) | 75 | 57 |
| 27(0.5) + C50(1) | 88 | 76 |
| 28(0.5) + H50(5) | 86 | 73 |
| 28(0.5) + C49(1) | 81 | 66 |
| 28(0.5) + C50(1) | 91 | 81 |
| 34(0.5) + H50(5) | 92 | 85 |
| 34(0.5) + C49(1) | 85 | 81 |
| 34(0.5) + C50(1) | 95 | 90 |
| 35(0.5) + H50(5) | 92 | 76 |
| 35(0.5) + C49(1) | 85 | 70 |
| 35(0.5) + C50(1) | 98 | 84 |
| 36(0.5) + H50(5) | 92 | 78 |
| 36(0.5) + C49(1) | 89 | 72 |
| 36(0.5) + C50(1) | 94 | 85 |
| 25(0.5) + A05(100) | 48 | 43 |
| 25(0.5) + A07(100) | 70 | 46 |
| 25(0.5) + A10(100) | 51 | 46 |
| 25(0.5) + B02(10) | 99 | 91 |
| 25(0.5) + B08(100) | 59 | 49 |
| 25(0.5) + C22(100) | 99 | 91 |
| 25(0.5) + C25(10) | 97 | 73 |
| 25(0.5) + C38(100) | 100 | 81 |
| 25(0.5) + C41(100) | 68 | 46 |
| 25(0.5) + C51(100) | 99 | 69 |
| 25(0.5) + D05(100) | 61 | 57 |
| 25(0.5) + D06(100) | 53 | 48 |
| 25(0.5) + G12(100) | 55 | 49 |
| 25(0.5) + G13(100) | 90 | 57 |
| 25(0.5) + H21(10) | 58 | 52 |
| 25(0.5) + H30(100) | 100 | 63 |
| 25(0.5) + H33(100) | 56 | 45 |
| 25(0.5) + H37(100) | 84 | 63 |
| 25(0.5) + H39(100) | 56 | 46 |
| 25(0.5) + H51(10) | 83 | 72 |
| 25(0.5) + I01(100) | 59 | 46 |
| 25(0.5) + I05(100) | 63 | 51 |
| 25(0.5) + I08(100) | 51 | 46 |
| 25(0.5) + L08(100) | 51 | 43 |
| 25(0.5) + L10(100) | 60 | 51 |
| 25(0.5) + L21(100) | 76 | 57 |
| 25(0.5) + L35(100) | 66 | 54 |
| 25(0.5) + M02(100) | 54 | 48 |
| 25(0.5) + M08(100) | 81 | 46 |
| 25(0.5) + M20(10) | 93 | 76 |
| 25(0.5) + M21(1) | 96 | 79 |
| 25(0.5) + M23(100) | 94 | 72 |
| 25(0.5) + M34(100) | 56 | 46 |
| 25(0.5) + M44(10) | 71 | 57 |

### INDUSTRIAL APPLICABILITY

The composition of the present invention and the method of the present invention exhibit synergistic excellent controlling effects against pathogens that cause various diseases and can be utilized in a wide range of fields in the agricultural/horticultural fields.

The entire disclosures of Japanese Patent Application No. 2016-089737 filed on Apr. 27, 2016 and Japanese Patent Application No. 2017-041802 filed on Mar. 6, 2017 including specifications, claims, drawing and summaries are incorporated herein by reference in their entireties.

1: A fungicidal or bactericidal composition comprising synergistically effective amounts of the following active ingredient A and the following active ingredient B:
active ingredient A: an oxime-substituted amide compound represented by the following formula (I), or its N-oxide or its salt, 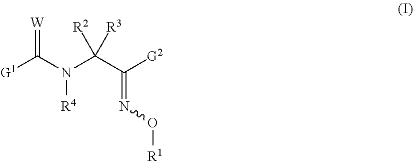
wherein in the formula (I),
G¹ is a structure of the following G¹-1, G¹-2, G¹-3, G¹-4, G¹-5, G¹-6, G¹-7, G¹-8 or G¹-9, 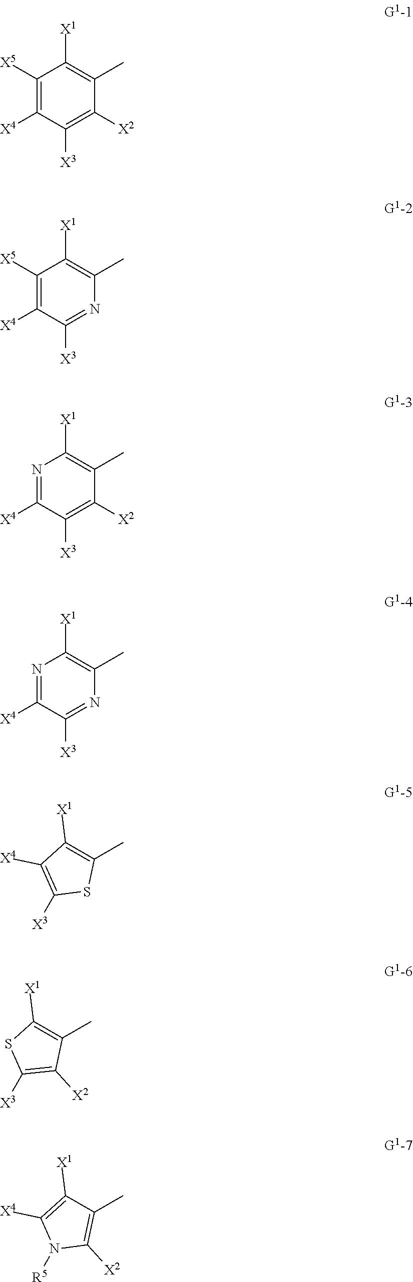 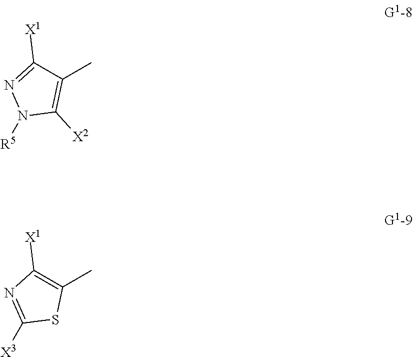
G² is a structure of the following G²-1 or G²-2, 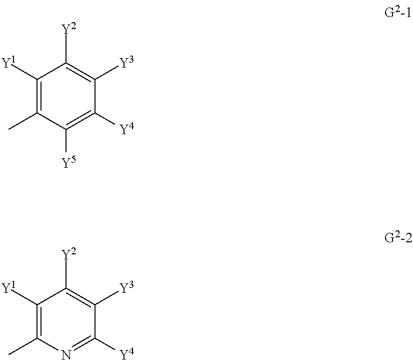
W is an oxygen atom or a sulfur atom,
X¹ is a halogen atom, nitro, methyl, difluoromethyl or trifluoromethyl,
X² is a hydrogen atom, and further when G¹ is a structure of G¹-8 and X¹ is trifluoromethyl, X² may be a halogen atom,
X³ is a hydrogen atom or methyl,
X⁴ is a hydrogen atom or a halogen atom,
X⁵ is a hydrogen atom,
Y¹ is a hydrogen atom, a halogen atom, methyl, trifluoromethyl or methoxy,
Y² is a hydrogen atom, a halogen atom, cyano, C₁-C₆ alkoxy, methylthio, methylsulfinyl or methylsulfonyl,
Y³ is a hydrogen atom, a halogen atom, cyano, C₁-C₄ alkyl, trifluoromethyl, C₂-C₄ alkenyl, C₂-C₆ alkynyl, (C₂-C₆) alkynyl optionally substituted by R⁶, —OR^{7a}, C₁-C₄ alkylthio, —C(R⁸)═NOR⁹ or phenyl,
Y⁴ is a hydrogen atom or a halogen atom,
Y⁵ is a hydrogen atom,
R¹ is C₁-C₆ alkyl, halo (C₁-C₄) alkyl, (C₁-C₄) alkyl substituted by R¹⁰, C₃-C₆ cycloalkyl, C₃-C₆ alkenyl, halo (C₃-C₄) alkenyl, C₃-C₆ alkynyl or phenyl,
R² is a hydrogen atom, methyl or ethyl, provided that R² is methyl or ethyl when G¹ is a structure of G¹-1, X¹ is a chlorine atom, X², X³ and X⁵ each is a hydrogen atom, X⁴ is a hydrogen atom or a chlorine atom, and G² is a structure of G²-1, Y³ is a chlorine atom, Y¹, Y², Y⁴ and Y⁵ each is a hydrogen atom,
R³ is a hydrogen atom or methyl, or R² and R³ may together form a cyclopropyl ring,
R⁴ is a hydrogen atom, halo (C₁-C₄) alkylthio, C₁-C₄ alkylcarbonyl or C₁-C₄ alkoxycarbonyl,
R⁵ is methyl,
R⁶ is a halogen atom, C₃-C₆ cycloalkyl, hydroxy(C₃-C₆)cycloalkyl, C₅-C₆ cycloalkenyl, —OH, —OR^{7b}, C₁-C₄ alkylcarbonyloxy, C₁-C₄ alkylsulfonyloxy, C₁-C₄ alkylthio, trimethylsilyl, —C(R⁸)═NOR⁹, phenyl or phenyl substituted by (Z)ₘ,
R^{7a} and R^{7b} each independently is C₁-C₄ alkyl, halo (C₁-C₄) alkyl, C₁-C₄ alkoxy (C₁-C₂) alkyl, C₃-C₄ alkynyl or phenyl substituted by (Z)ₘ,
R⁸ is a hydrogen atom or methyl,
R⁹ is methyl or ethyl,
R¹⁰ is cyano, C₃-C₆ cycloalkyl, C₁-C₄ alkoxy, C₁-C₄ alkylthio, trimethylsilyl, —C(R¹¹)═NOR¹², phenyl or phenyl substituted by (Z)ₘ,
R¹¹ is methyl,
R¹² is methyl or ethyl,
Z is a halogen atom, cyano, nitro, C₁-C₄ alkyl, trifluoromethyl, methoxy, trifluoromethoxy, trifluoromethylthio or phenyl, and when m is 2 or more, the respective Z's may be identical with or different from one another, and when there are two neighboring Z's, the two neighboring Z's may form —CH═CH—CH═CH— to form a 6-membered ring together with the carbon atoms attached to the two Z's, and
m is an integer of 1, 2 or 3,
active ingredient B: one or more compounds selected from the group consisting the following B-I group to B-XV group,
B-I group: pydiflumetofen, pyraziflumid and 1-(2-[([1-(4-chlorophenyl)-1H-pyrazol-3-yl]oxy)-methyl]-3-methylphenyl)-4-methyl-1,4-dihydro-5H-tetrazol-5-one,
B-II group: fenpyrazamine,
B-III group: metalaxyl-M, oxadixyl and hymexazol,
B-IV group: carbendazim and zoxamide,
B-V group: enoxastrobin, fenaminstrobin, triclopyricarb and cyazofamid,
B-VI group: kasugamycin and streptomycin,
B-VII group: propamocarb hydrochloride and Bacillus subtilis,
B-VIII group: imibenconazole, propiconazole, pyrisoxazole, triadimefon and triflumizole,
B-IX group: mefentrifluconazole,
B-X group: validamycin, dimethomorph and mandipropamid,
B-XI group: copper oxychloride, basic copper sulfate and thiram,
B-XII group: zineb,
B-XIII group: cymoxanil and fosetyl-aluminium,
B-XIV group: quinofumelin, 2-(2-[(7,8-difluoro-2-methylquinolin-3-yl)oxy]-6-fluoro-phenyl)propan-2-ol, dipymetitrone, ethylicin and 3-chloro-4-(2,6-difluorophenyl)-6-methyl-5-phenyl-pyridazine, and
B-XV group: dimetachlone, zhongshengmycin, thiodiazole-copper, zinc thiazole, fenaminosulf, wuyiencin, ningnanmycin, berberine and copper(I) oxide.

2: The fungicidal or bactericidal composition according to claim 1, wherein the active ingredient A is the compound of formula (I), or its N-oxide or its salt, wherein,
W is an oxygen atom,
X¹ is a halogen atom, methyl, difluoromethyl or trifluoromethyl,
X² is a hydrogen atom,
X⁴ is a hydrogen atom,
Y¹ is a halogen atom,
Y² is a hydrogen atom, a halogen atom, C₁-C₆ alkoxy, methylthio, methylsulfinyl or methylsulfonyl,
Y³ is a halogen atom, trifluoromethyl, C₂-C₄ alkenyl, C₂-C₆ alkynyl, (C₂-C₄) alkynyl optionally substituted by R⁶, —OR^{7a} or —C(R⁸)═NOR⁹,
R¹ is C₁-C₆ alkyl, halo (C₁-C₄) alkyl, (C₁-C₄) alkyl substituted by R¹⁰, C₃-C₆ cycloalkyl, C₃-C₆ alkenyl, halo (C₁-C₄) alkenyl or C₃-C₆ alkynyl,
R² is a hydrogen atom or methyl, provided that R² is methyl when G² is a structure of G²-1,
R³ is a hydrogen atom,
R⁴ is a hydrogen atom,
R⁶ is a halogen atom, C₃-C₆ cycloalkyl, —OR^{7b}, trimethylsilyl, —C(R₈)═NOR⁹ or phenyl,
R^{7a} is halo (C₁-C₄) alkyl,
R^{7b} is C₁-C₄ alkyl or C₁-C₄ alkoxymethyl,
R¹⁰ is C₃-C₆ cycloalkyl, trimethylsilyl, phenyl or phenyl substituted by (Z)ₘ, and
Z is a halogen atom or cyano, and when m is 2 or more, the respective Z's may be identical with or different from one another.

3: The fungicidal or bactericidal composition according to claim 2, wherein the active ingredient A is the compound of formula (I), or its N-oxide or its salt, wherein,
G¹ is a structure of G¹-1, G¹-3, G¹-8 or G¹-9,
G² is a structure of G²-2,
X¹ is a chlorine atom, difluoromethyl or trifluoromethyl,
Y¹ is a chlorine atom or a bromine atom,
Y² is a hydrogen atom, C₁-C₄ alkoxy or methylsulfonyl,
Y³ is a chlorine atom, a bromine atom, trifluoromethyl, C₂-C₆ alkynyl or (C₂-C₆) alkynyl optionally substituted by R⁶,
Y⁴ is a hydrogen atom,
R¹ is C₁-C₄ alkyl, halo (C₁-C₄) alkyl or cyclopropylmethyl,
R² is a hydrogen atom or methyl, and
R⁶ is cyclopropyl or phenyl.

4: The fungicidal or bactericidal composition according to claim 3, wherein the active ingredient A is the compound of formula (I), or its N-oxide or its salt, wherein,
G¹ is a structure of G¹-1,
X¹ is trifluoromethyl, and
X³ is a hydrogen atom.

5: The fungicidal or bactericidal composition according to claim 3, wherein the active ingredient A is the compound of formula (I), or its N-oxide or its salt, wherein,
G¹ is a structure of G¹-3,
X¹ is a chlorine atom or difluoromethyl, and
X³ is a hydrogen atom.

6: The fungicidal or bactericidal composition according to claim 3, wherein the active ingredient A is the compound of formula (I), or its N-oxide or its salt, wherein,
G¹ is a structure of G¹-8, and
X¹ is difluoromethyl.

7: The fungicidal or bactericidal composition according to claim 3, wherein the active ingredient A is the compound of formula (I), or its N-oxide or its salt, wherein,
G¹ is a structure of G¹-9,
X¹ is difluoromethyl, and
X³ is methyl.

8: The fungicidal or bactericidal composition according to claim 1, wherein the active ingredient B is a compound selected from the B-I group.

9: The fungicidal or bactericidal composition according to claim 1, wherein the active ingredient B is a compound selected from the B-II group.

10: The fungicidal or bactericidal composition according to claim 1, wherein the active ingredient B is a compound selected from the B-III group to the B-VIII group, the B-X group to B-XIII group and the B-XV group.

11: The fungicidal or bactericidal composition according to claim 1, wherein the active ingredient B is a compound selected from the B-IX group.

12: The fungicidal or bactericidal composition according to claim 1, wherein the active ingredient B is a compound selected from the B-XIV group.

13: The fungicidal or bactericidal composition according to claim 1, wherein the active ingredient B is contained in a proportion of from 0.001 to 1,000 parts by weight, relative to 1 part by weight of the active ingredient A.

14: A method for controlling disease or bacteria, comprising:
treating at the same time or in close temporal proximity with the following active ingredient A and the following active ingredient B;
active ingredient A: an oxime-substituted amide compound represented by the following formula (I), or its N-oxide or its salt, 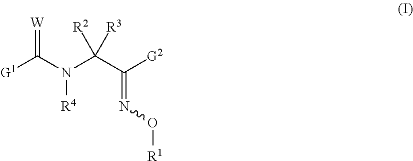
wherein in the formula (I),
G¹ is a structure of the following G¹-1, G¹-2, G¹-3, G¹-4, G¹-5, G¹-6, G¹-7, G¹-8 or G¹-9, 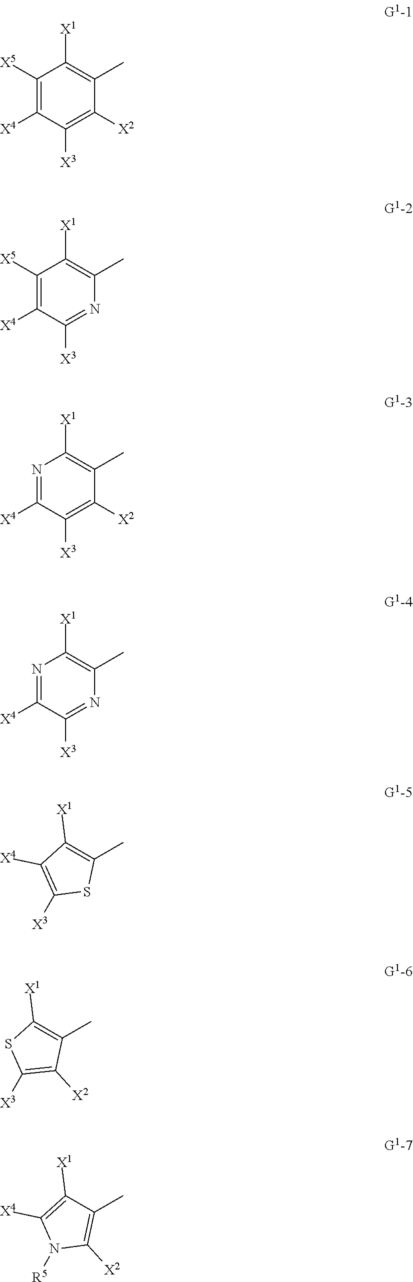 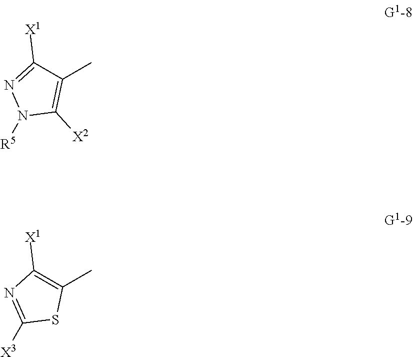
G² is a structure of the following G²-1 or G²-2, 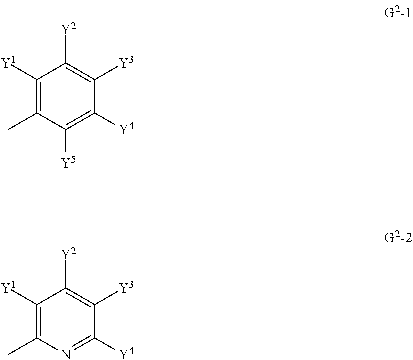
W is an oxygen atom or a sulfur atom,
X¹ is a halogen atom, nitro, methyl, difluoromethyl or trifluoromethyl,
X² is a hydrogen atom, and further when G¹ is a structure of G¹-8 and X¹ is trifluoromethyl, X² may be a halogen atom,
X³ is a hydrogen atom or methyl,
X⁴ is a hydrogen atom or a halogen atom,
X⁵ is a hydrogen atom,
Y¹ is a hydrogen atom, a halogen atom, methyl, trifluormethyl or methoxy,
Y² is a hydrogen atom, a halogen atom, cyano, C₁-C₄ alkoxy, methylthio, methylsulfinyl or methylsulfonyl,
Y³ is a hydrogen atom, a halogen atom, cyano, C₁-C₄ alkyl, trifluoromethyl, C₂-C₄ alkenyl, C₂-C₆ alkynyl, (C₂-C₆) alkynyl optionally substituted by R^{6e}, —OR^{7a}, C₁-C₄ alkylthio, —C(R⁸)═NOR⁹ or phenyl,
Y⁴ is a hydrogen atom or a halogen atom,
Y⁵ is a hydrogen atom,
R¹ is C₁-C₆ alkyl, halo (C₁-C₄) alkyl, (C₁-C₄) alkyl substituted by R¹⁰, C₃-C₆ cycloalkyl, C₃-C₆ alkenyl, halo (C₃-C₄) alkenyl, C₃-C₆ alkynyl or phenyl,
R² is a hydrogen atom, methyl or ethyl, provided that R² is methyl or ethyl when G¹ is a structure of G¹-1, X¹ is a chlorine atom, X², X³ and X⁵ each is a hydrogen atom, X⁴ is a hydrogen atom or a chlorine atom, and G² is a structure of G²-1, Y³ is a chlorine atom, Y¹, Y², Y⁴ and Y⁵ each is a hydrogen atom,
R³ is a hydrogen atom or methyl, or R² and R³ may together form a cyclopropyl ring,
R⁴ is a hydrogen atom, halo (C₁-C₄) alkylthio, C₁-C₄ alkylcarbonyl or C₁-C₄ alkoxycarbonyl,
R⁵ is methyl,
R⁶ is a halogen atom, C₃-C₆ cycloalkyl, hydroxy(C₃-C₆)cycloalkyl, C₅-C₆ cycloalkenyl, —OH, —OR^{7b}, C₁-C₄ alkylcarbonyloxy, C₁-C₄ alkylsulfonyloxy, C₁-C₄ alkylthio, trimethylsilyl, —C(R⁸)═NOR⁹, phenyl or phenyl substituted by (Z)ₘ,
R^{7a} and R^{7b} each independently is C₁-C₄ alkyl, halo (C₁-C₄) alkyl, C₁-C₄ alkoxy (C₁-C₂) alkyl, C₃-C₄ alkynyl or phenyl substituted by (Z)ₘ,
R⁸ is a hydrogen atom or methyl,
R⁹ is methyl or ethyl,
R¹⁰ is cyano, C₃-C₆ cycloalkyl, C₁-C₄ alkoxy, C₁-C₄ alkylthio, trimethylsilyl, —C(R¹¹)═NOR¹², phenyl or phenyl substituted by (Z)ₘ,
R¹¹ is methyl,
R¹² is methyl or ethyl,
Z is a halogen atom, cyano, nitro, C₁-C₄ alkyl, trifluoromethyl, methoxy, trifluoromethoxy, trifluoromethytthio or phenyl, and when m is 2 or more, the respective Z's may be identical with or different from one another, and when there are two neighboring Z's, the two neighboring Z's may form —CH═CH—CH═CH— to form a 6-membered ring together with the carbon atoms attached to the two Z's,
m is an integer of 1, 2 or 3,
active ingredient B: one or more compounds selected from the group consisting the following B-I group to B-XV group,
B-I group: pydiflumetofen, pyraziflumid and 1-(2-[([1-(4-chlorophenyl)-1H-pyrazol-3-yl]oxy)-methyl]-3-methylphenyl)-4-methyl-1,4-dihydro-5H-tetrazol-5-one,
B-II group: fenpyrazamine,
B-III group: metalaxy-M, oxadixyl and hymexazol,
B-IV group: carbendazim and zoxamide,
B-V group: enoxastrobin, fenaminstrobin, triclopyricarb and cyazofamid,
B-VI group: kasugamycin and streptomycin,
B-VII group: propamocarb hydrochloride and Bacillus subtilis,
B-VIII group: imibenconazole, propiconazole, pyrisoxazole, triadimefon and triflumizole,
B-IX group: mefentrifluconazole,
B-X group: validamycin, dimethomorph and mandipropamid,
B-XI group: copper oxychloride, basic copper sulfate and thiram,
B-XII group: zineb,
B-XIII group: cymoxanil and fosetyl-aluminium,
B-XIV group: quinofumelin, 2-(2-[(7,8-difluoro-2-methylquinolin-3-yl)oxy]-6-fluoro-phenyl)propan-2-ol, dipymetitrone, ethylicin and 3-chloro-4-(2,6-difluorophenyl)-6-methyl-5-phenyl-pyridazine, and
B-XV group: dimetachlone, zhongshengmycin, thiodiazole-copper, zinc thiazole, fenaminosuif, wuyiencin, ningnanmycin, berberine and copper(I) oxide.

15: The method according to claim 14, wherein the active ingredient B is used in a proportion of from 0.001 to 1,000 parts by weight, relative to 1 part by weight of the active ingredient A.

16: A method for controlling disease or bacteria, comprising:
applying the composition according to claim 1 by foliage application to a plant.

17: A method for controlling disease or bacteria, comprising:
applying the composition according to claim 1, to a soil for plant growth.

18: A method for controlling disease or bacteria, comprising:
applying the composition according to claim 1, to seeds, a tuberous root or rhizome of a plant.
